(19) United States
(12) Patent Application Publication
(10) Pub. No.: US 2018/0189555 A1
(43) Pub. Date: Jul. 5, 2018

(54) METHOD EXECUTED ON COMPUTER FOR COMMUNICATING VIA VIRTUAL SPACE, PROGRAM FOR EXECUTING THE METHOD ON COMPUTER, AND COMPUTER APPARATUS THEREFOR

(71) Applicant: COLOPL, Inc., Tokyo (JP)

(72) Inventor: Seiji SATAKE, Tokyo (JP)

(21) Appl. No.: 15/853,923

(22) Filed: Dec. 25, 2017

(30) Foreign Application Priority Data
Dec. 26, 2016 (JP) 2016-251500

(51) Int. Cl. G06K 9/00; G06T 19/00; G06T 13/40; G06F 3/01

(52) U.S. Cl. CPC G06K 9/00335; G06F 3/011; G06T 13/40; G06T 19/006

(57) ABSTRACT

[Summary]

[Object] To provide a method capable of facilitating interaction among a plurality of users in a virtual space.

[Solving Means] Provided is a method including: defining a virtual space, the virtual space including a first object and a second object; detecting a motion of a part of a body of a first user; moving the first object in response to the motion; identifying a direction indicated by the moved first object; identifying a line of sight of the second object; and changing the identified line of sight such that the line of sight is directed toward the identified direction.

### TECHNICAL FIELD

This disclosure relates to a technology for providing a virtual space, and more particularly, to provision of communication via the virtual space.

### BACKGROUND ART

A technology of providing a virtual space using a head mount device (HMD) is now widely used. For example, in Japanese Patent Application Laid-open No. 2009-223656 (Patent Document 1), there is disclosed a technology for encouraging communication among a plurality of users by operation of avatar objects presented in a virtual space. This technology involves causing respective computers of the plurality of users to communicate to/from each other on a network, to thereby present avatar objects corresponding to the respective users in the virtual space and move the avatar objects in the virtual space such that motions of the avatar objects correspond to motions of the respective users in a real space. Through use of such a technology, for example, each user is allowed to play a common game with an avatar object of a different user (hereinafter also referred to as “different avatar object”) or have a conversation (so-called “chat”) with the different avatar object, while moving an avatar object existing in the virtual space.

### RELATED ART

### Patent Documents

[Patent Document 1] JP 2009-223656 A

### SUMMARY

### Means for solving the Problem

According to one embodiment of this disclosure, there is provided a method including: defining a virtual space, the virtual space including a first object and a second object; detecting a motion of a part of a body of a first user; moving the first object in response to the motion; identifying a direction indicated by the moved first object; identifying a line of sight of the second object; and changing the line of sight such that the line of sight is directed toward the direction.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram for illustrating an overview of a configuration of an HMD system in one embodiment of this disclosure.

FIG. 2 A block diagram for illustrating an example of a hardware configuration of a computer in one embodiment of this disclosure.

FIG. 3 A diagram for schematically illustrating a uvw visual-field coordinate system to be set for an HMD in one embodiment of this disclosure.

FIG. 4 A diagram for schematically illustrating one mode of expressing a virtual space in one embodiment of this disclosure.

FIG. 5 A diagram for illustrating, from above, a head of a user wearing the HMD in one embodiment of this disclosure.

FIG. 6 A diagram for illustrating a YZ cross section obtained by viewing a field-of-view region from an X direction in the virtual space.

FIG. 7 A diagram for illustrating an XZ cross section obtained by viewing the field-of-view region from a Y direction in the virtual space.

FIGS. 8A Diagrams for illustrating a schematic configuration of a controller in one embodiment of this disclosure.

FIG. 8B A diagram for illustrating an example of a yaw direction, a roll direction, and a pitch direction that are defined with respect to a right hand of the user in one embodiment of this disclosure.

FIG. 9 A block diagram for illustrating an example of a hardware configuration of a server in one embodiment of this disclosure.

FIG. 10 A block diagram for illustrating a computer in one embodiment of this disclosure in terms of its module configuration.

FIG. 11 A sequence chart for illustrating a part of processing to be executed by an HMD set in one embodiment of this disclosure.

FIGS. 12A Schematic diagrams for illustrating a situation in which each HMD provides the user with the virtual space in a network.

FIG. 12B A diagram for illustrating a field-of-view image of a user 5A in FIG. 12A.

FIG. 13 A sequence diagram for illustrating processing to be executed by the HMD system in one embodiment of this disclosure.

FIG. 14 A block diagram for illustrating a detailed configuration of modules of the computer according to one embodiment of this disclosure.

FIG. 15 A diagram for schematically illustrating one mode of representation of respective virtual spaces presented by a plurality of computers.

FIG. 16 A sequence chart for illustrating a part of processing to be executed by the HMD system in one embodiment of this disclosure.

FIG. 17 A sequence chart for illustrating a part of detailed processing to be executed by the HMD system in one embodiment of this disclosure.

FIG. 18 A sequence chart for illustrating a part of communication between a plurality of computers.

FIG. 19 A flowchart for illustrating detailed processing to be executed by the processor of the computer in one aspect of one embodiment of this disclosure.

FIG. 20A A diagram for illustrating an example of a field-of-view image in one embodiment of this disclosure.

FIG. 20B A diagram for illustrating an example of presentation of an object in the virtual space in one embodiment of this disclosure.

FIG. 21 A diagram for illustrating an example of a change in object presented in the virtual space in one embodiment of this disclosure.

FIG. 22 A diagram for illustrating an example of the change in object presented in the virtual space in one embodiment of this disclosure.

FIG. 23A A diagram for illustrating an example of a field-of-view image in one embodiment of this disclosure.

FIG. 23B A diagram for illustrating an example of presentation of an object in the virtual space in another aspect of one embodiment of this disclosure.

FIG. 24 A flowchart for illustrating detailed processing to be executed by a processor of the computer in another aspect of one embodiment of this disclosure.

FIG. 25 A diagram for illustrating an example of a change in object presented in the virtual space in another aspect of one embodiment of this disclosure.

FIG. 26 A flowchart for illustrating detailed processing to be executed by the processor of the computer in another aspect of one embodiment of this disclosure.

FIG. 27 A flowchart for illustrating detailed processing to be executed by the processor of the computer in another aspect of one embodiment of this disclosure.

### DESCRIPTION OF EMBODIMENTS

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

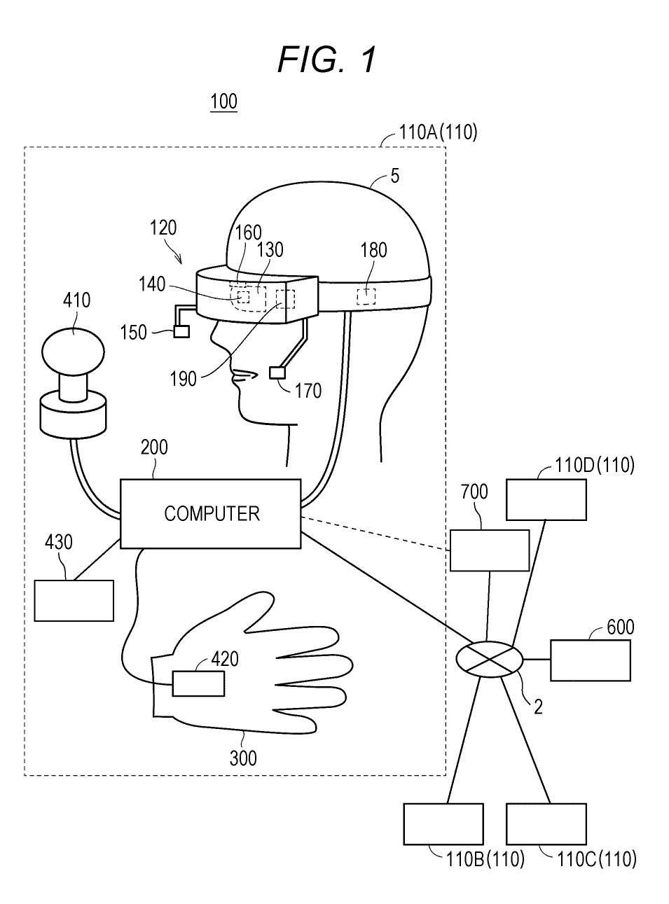

With reference to FIG. 1, a configuration of a head-mounted device (HMD) system 100 is described. FIG. 1 is a diagram for illustrating an overview of the configuration of the HMD system 100 in one embodiment of this disclosure. The HMD system 100 is provided as a system for household use or a system for professional use.

The HMD system 100 includes a server 600, HMD sets 110A, 110B, 110C, and 110D, an external device 700, and a network 2. Each of the HMD sets 110A, 110B, 110C, and 110D is capable of communicating to/from the server 600 or the external device 700 via the network 2. In the following, the HMD sets 110A, 110B, 110C, and 110D are also collectively referred to as “HMD set 110”. The number of HMD sets 110 constructing the HMD system 100 is not limited to four, but maybe three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. The controller 300 may include a motion sensor 420.

In one aspect, the computer 200 can be connected to the network 2, for example, the Internet, and can communicate to/from the server 600 or other computers connected to the network 2. Examples of the other computers include a computer of another HMD set 110 and the external device 700. In another aspect, the HMD 120 may include a sensor 190 instead of the HMD sensor 410.

The HMD 120 may be worn on a head of a user 5 to provide a virtual space to the user 5 during operation. More specifically, the HMD 120 displays each of a right-eye image and a left-eye image on the monitor 130. When each eye of the user 5 visually recognizes each image, the user 5 may recognize the image as a three-dimensional image based on the parallax of both the eyes. The HMD 120 may include any one of a so-called head-mounted display including a monitor and a head-mounted device capable of mounting a smartphone or other terminals including a monitor.

The monitor 130 is implemented as, for example, a non-transmissive display device. In one aspect, the monitor 130 is arranged on a main body of the HMD 120 so as to be positioned in front of both the eyes of the user 5. Therefore, when the user 5 visually recognizes the three-dimensional image displayed on the monitor 130, the user 5 can be immersed in the virtual space. In one aspect, the virtual space includes, for example, a background, objects that can be operated by the user 5, and menu images that can be selected by the user 5. In one aspect, the monitor 130 may be implemented as a liquid crystal monitor or an organic electroluminescence (EL) monitor included in a so-called smartphone or other information display terminals.

In another aspect, the monitor 130 may be implemented as a transmissive display device. In this case, the HMD 120 is not a non-see-through HMD covering the eyes of the user 5 illustrated in FIG. 1, but maybe a see-through HMD, for example, smartglasses. The transmissive monitor 130 may be configured as a temporarily non-transmissive display device through adjustment of a transmittance thereof. The monitor 130 may be configured to display a real space and a part of an image constructing the virtual space at the same time. For example, the monitor 130 may display an image of the real space captured by a camera mounted on the HMD 120, or may enable recognition of the real space by setting the transmittance of a part the monitor 130 high.

In one aspect, the monitor 130 may include a sub-monitor for displaying a right-eye image and a sub-monitor for displaying a left-eye image. In another aspect, the monitor 130 may be configured to integrally display the right-eye image and the left-eye image. In this case, the monitor 130 includes a high-speed shutter. The high-speed shutter operates so as to enable alternate display of the right-eye image and the left-eye image so that only one of the eyes can recognize the image.

In one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In another aspect, the HMD sensor 410 may be implemented by a camera. In this case, the HMD sensor 410 may use image information of the HMD 120 output from the camera to execute image analysis processing, to thereby enable detection of the position and the inclination of the HMD 120.

In another aspect, the HMD 120 may include the sensor 190 instead of, or in addition to, the HMD sensor 410 as a position detector. The HMD 120 may use the sensor 190 to detect the position and the inclination of the HMD 120 itself. For example, when the sensor 190 is an angular velocity sensor, a geomagnetic sensor, or an acceleration sensor, the HMD 120 may use any of those sensors instead of the HMD sensor 410 to detect the position and the inclination of the HMD 120 itself. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In one aspect, the eye gaze sensor 140 is preferred to include a right-eye sensor and a left-eye sensor. The eye gaze sensor 140 may be, for example, a sensor configured to irradiate the right eye and the left eye of the user 5 with an infrared ray, and to receive reflection light from the cornea and the iris with respect to the irradiation light, to thereby detect a rotational angle of each eyeball. The eye gaze sensor 140 can detect the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In one aspect, the first camera 150 may be arranged outside of the HMD 120, and the second camera 160 may be arranged inside of the HMD 120. Images generated by the first camera 150 and the second camera 160 are input to the computer 200. In another aspect, the first camera 150 and the second camera 160 may be implemented as one camera, and the face of the user 5 may be photographed with this one camera.

The microphone 170 converts an utterance of the user 5 into a voice signal (electric signal) for output to the computer 200. The speaker 180 converts the voice signal into a voice for output to the user 5. In another aspect, the HMD 120 may include earphones in place of the speaker 180.

The controller 300 is connected to the computer 200 through wired or wireless communication. The controller 300 receives input of a command from the user 5 to the computer 200. In one aspect, the controller 300 can be held by the user 5. In another aspect, the controller 300 can be mounted to the body or a part of the clothes of the user 5. In still another aspect, the controller 300 may be configured to output at least any one of a vibration, a sound, or light based on the signal transmitted from the computer 200. In yet another aspect, the controller 300 receives from the user 5 an operation for controlling the position and the motion of an object arranged in the virtual space.

In one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In another aspect, the HMD sensor 410 may be implemented by a camera. In this case, the HMD sensor 410 may use image information of the controller 300 output from the camera to execute image analysis processing, to thereby enable detection of the position and the inclination of the controller 300.

In one aspect, the motion sensor 420 is mounted on the hand of the user 5 to detect the motion of the hand of the user 5. For example, the motion sensor 420 detects a rotational speed and the number of rotations of the hand. The detected signal is transmitted to the computer 200. The motion sensor 420 is provided to, for example, the controller 300. In one aspect, the motion sensor 420 is provided to, for example, the controller 300 capable of being held by the user 5. In another aspect, for the safety in the real space, the controller 300 is mounted on an object like a glove-type object that does not easily fly away by being worn on a hand of the user 5. In still another aspect, a sensor that is not mounted on the user 5 may detect the motion of the hand of the user 5. For example, a signal of a camera that photographs the user 5 may be input to the computer 200 as a signal representing the motion of the user 5. As one example, the motion sensor 420 and the computer 200 are connected to each other through wireless communication. In the case of wireless communication, the communication mode is not particularly limited, and for example, Bluetooth (trademark) or other known communication methods are used.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

The server 600 may transmit a program to the computer 200. In another aspect, the server 600 may communicate to/from another computer 200 for providing virtual reality to the HMD 120 used by another user. For example, when a plurality of users play a participatory game in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 may be any device as long as the external device 700 can communicate to/from the computer 200. The external device 700 may be, for example, a device capable of communicating to/from the computer 200 via the network 2, or may be a device capable of directly communicating to/from the computer 200 by near field communication or wired communication. Peripheral devices such as a smart device, a personal computer (PC), and the computer 200 may be used as the external device 700, but the external device 700 is not limited thereto.

[Hardware Configuration of Computer]

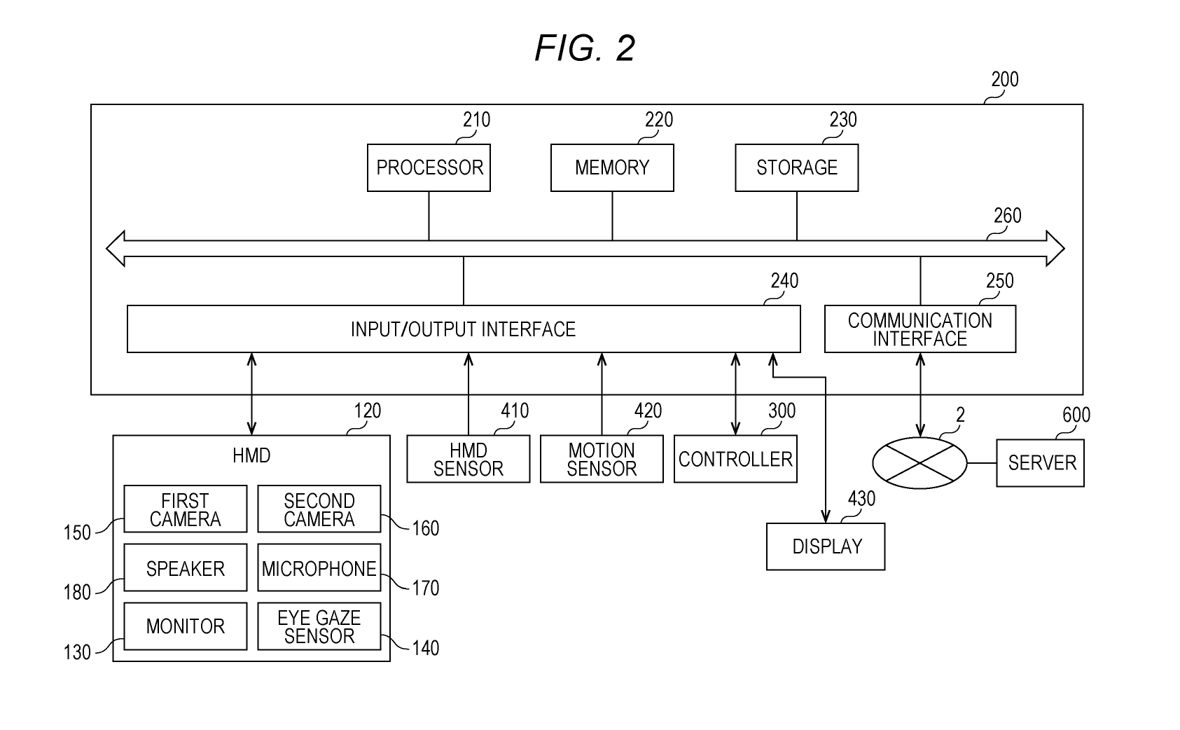

With reference to FIG. 2, the computer 200 in this embodiment is described. FIG. 2 is a block diagram for illustrating an example of the hardware configuration of the computer 200 in this embodiment. The computer 200 includes, as primary components, a processor 210, a memory 220, a storage 230, an input/output interface 240, and a communication interface 250. Each component is connected to a bus 260.

The processor 210 executes a series of commands included in a program stored in the memory 220 or the storage 230 based on a signal transmitted to the computer 200 or on satisfaction of a condition determined in advance. In one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In one aspect, the memory 220 is implemented as a random access memory (RAM) or other volatile memories.

The storage 230 permanently stores programs and data. The storage 230 is implemented as, for example, a read-only memory (ROM), a hard disk device, a flash memory, or other non-volatile storage devices. The programs stored in the storage 230 include programs for providing a virtual space in the HMD system 100, simulation programs, game programs, user authentication programs, and programs for implementing communication to/from other computers 200. The data stored in the storage 230 includes data and objects for defining the virtual space.

In another aspect, the storage 230 may be implemented as a removable storage device like a memory card. In still another aspect, a configuration that uses programs and data stored in an external storage device may be used instead of the storage 230 built into the computer 200. With such a configuration, for example, in a situation in which a plurality of HMD systems 100 are used as in an amusement facility, the programs and the data can be collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In one aspect, the input/output interface 240 is implemented with use of a universal serial bus (USB), a digital visual interface (DVI), a high-definition multimedia interface (HDMI) (trademark), or other terminals. The input/output interface 240 is not limited to ones described above.

In one aspect, the input/output interface 240 may further communicate to/from the controller 300. For example, the input/output interface 240 receives input of a signal output from the controller 300 and the motion sensor 420. In another aspect, the input/output interface 240 transmits a command output from the processor 210 to the controller 300. The command instructs the controller 300 to, for example, vibrate, output a sound, or emit light. When the controller 300 receives the command, the controller 300 executes anyone of vibration, sound output, and light emission in accordance with the command.

The communication interface 250 is connected to the network 2 to communicate to/from other computers (e.g., server 600) connected to the network 2. In one aspect, the communication interface 250 is implemented as, for example, a local area network (LAN), other wired communication interfaces, wireless fidelity (Wi-Fi), Bluetooth (trademark), near field communication (NFC), or other wireless communication interfaces. The communication interface 250 is not limited to ones described above.

In one aspect, the processor 210 accesses the storage 230 and loads one or more programs stored in the storage 230 to the memory 220 to execute a series of commands included in the program. The one or more programs may include an operating system of the computer 200, an application program for providing a virtual space, and game software that can be executed in the virtual space. The processor 210 transmits a signal for providing a virtual space to the HMD 120 via the input/output interface 240. The HMD 120 displays a video on the monitor 130 based on the signal.

In the example illustrated in FIG. 2, the computer 200 is provided outside of the HMD 120, but in another aspect, the computer 200 may be built into the HMD 120. As an example, a portable information communication terminal (e.g., smartphone) including the monitor 130 may function as the computer 200.

The computer 200 may be used in common among a plurality of HMDs 120. With such a configuration, for example, the same virtual space can be provided to a plurality of users, and hence each user can enjoy the same application with other users in the same virtual space.

According to one embodiment of this disclosure, in the HMD system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which correspond to the motion of the user 5 wearing the HMD 120, based on the value of each point (each coordinate value in the real coordinate system). In more detail, the HMD sensor 410 can detect the temporal change of the position and the inclination of the HMD 120 with use of each value detected over time.

Each inclination of the HMD 120 detected by the HMD sensor 410 corresponds to each inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-Field Coordinate System]

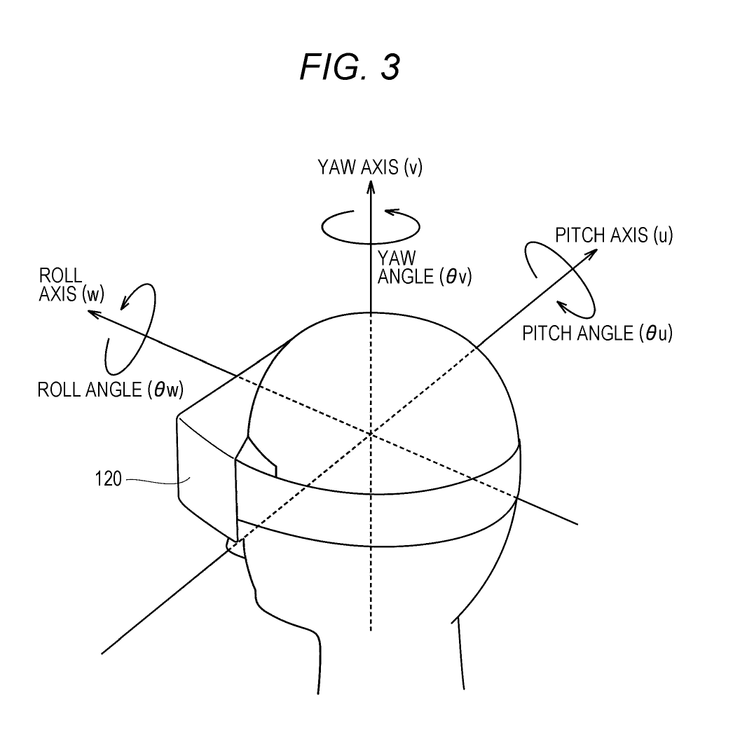

With reference to FIG. 3, the uvw visual-field coordinate system is described. FIG. 3 is a diagram for schematically illustrating a uvw visual-field coordinate system to be set for the HMD 120 in one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

As illustrated in FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In one aspect, when the user 5 wearing the HMD 120 is standing upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 can detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is always constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In one aspect, the HMD sensor 410 may identify the position of the HMD 120 in the real space as a position relative to the HMD sensor 410 based on the light intensity of the infrared ray or a relative positional relationship between a plurality of points (e.g., distance between points), which is acquired based on output from the infrared sensor. The processor 210 may determine the origin of the uvw visual-field coordinate system of the HMD 120 in the real space (real coordinate system) based on the identified relative position.

[Virtual Space]

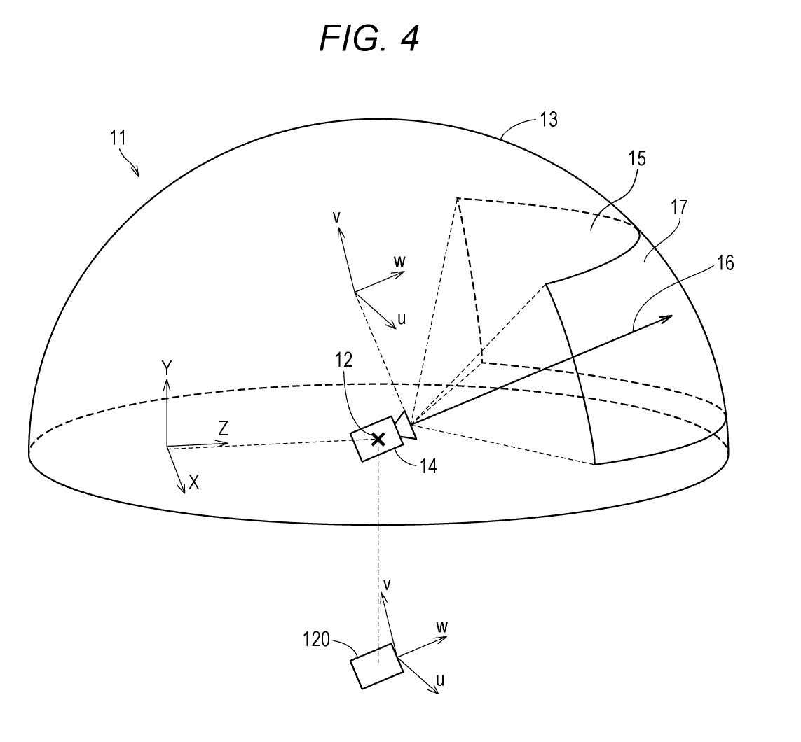

With reference to FIG. 4, the virtual space is further described. FIG. 4 is a diagram for schematically illustrating one mode of expressing a virtual space 11 in one embodiment of this disclosure. The virtual space 11 has a structure with an entire celestial sphere shape covering a center 12 in all 360-degree directions. In FIG. 4, in order to avoid complicated description, only the upper-half celestial sphere of the virtual space 11 is exemplified. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that can be developed in the virtual space 11 with each corresponding mesh section in the virtual space 11.

In one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space maybe reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 can be said to be a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the HMD system 100 in one aspect, the line of sight of the user 5 detected by the eye gaze sensor 140 can be regarded as the line of sight of the user 5 in the uvw visual-field coordinate system of the virtual camera 14.

[User's Line of Sight]

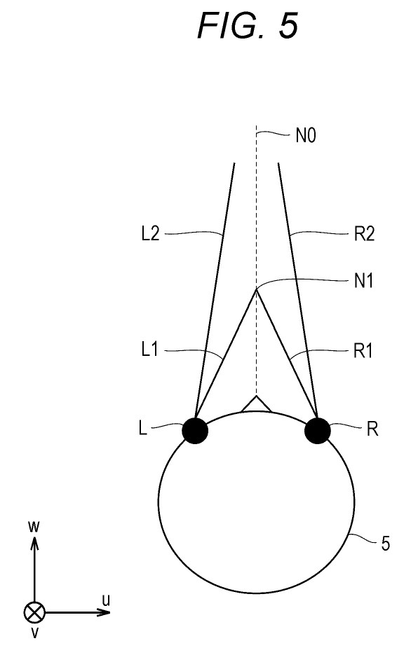

With reference to FIG. 5, determination of the line of sight of the user 5 is described. FIG. 5 is a diagram for illustrating, from above, the head of the user 5 wearing the HMD 120 in one embodiment of this disclosure.

In one aspect, the eye gaze sensor 140 detects lines of sight of the right eye and the left eye of the user 5. In one aspect, when the user 5 is looking at a near place, the eye gaze sensor 140 detects lines of sight R1 and L1. In another aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight NO of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In another aspect, the HMD system 100 may include a television broadcast reception tuner. With such a configuration, the HMD system 100 can display a television program in the virtual space 11.

In still another aspect, the HMD system 100 may include a communication circuit for connecting to the Internet or have a verbal communication function for connecting to a telephone line.

[Field-of-View Region]

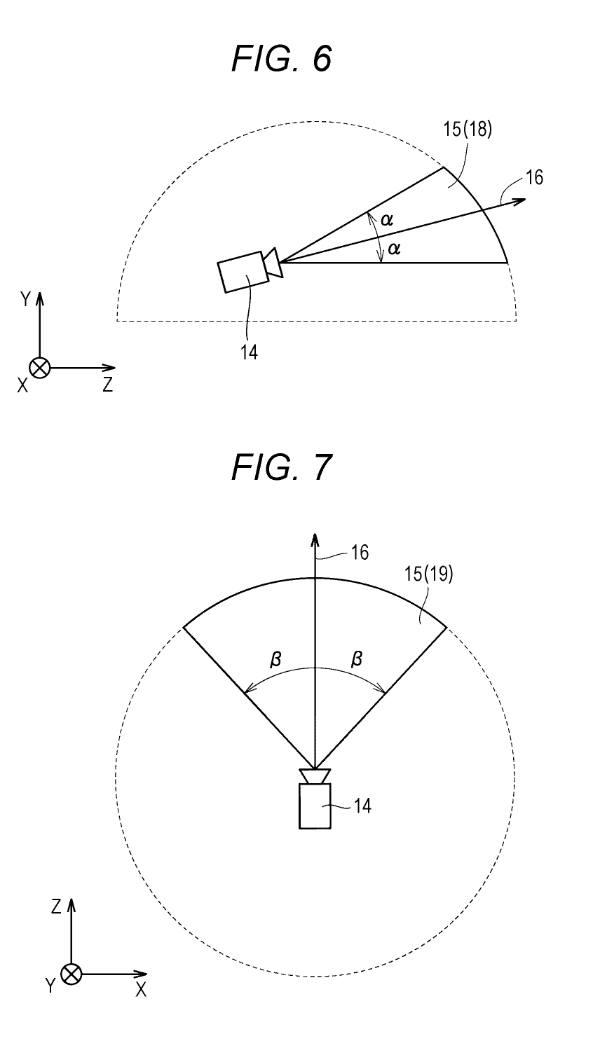

With reference to FIG. 6 and FIG. 7, the field-of-view region 15 is described. FIG. 6 is a diagram for illustrating a YZ cross section obtained by viewing the field-of-view region 15 from an X direction in the virtual space 11. FIG. 7 is a diagram for illustrating an XZ cross section obtained by viewing the field-of-view region 15 from a Y direction in the virtual space 11.

As illustrated in FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle a from the reference line of sight 16 serving as the center in the virtual space as the region 18.

As illustrated in FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In one aspect, the HMD system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120, the user 5 can visually recognize only the panorama image 13 developed in the virtual space 11 without visually recognizing the real world. Therefore, the HMD system 100 can provide a high sense of immersion in the virtual space 11 to the user 5.

In one aspect, the processor 210 may move the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In one aspect, the virtual camera 14 may include two virtual cameras, that is, a virtual camera for providing a right-eye image and a virtual camera for providing a left-eye image. An appropriate parallax is set for the two virtual cameras so that the user 5 can recognize the three-dimensional virtual space 11. In another aspect, the virtual camera 14 may be implemented by one virtual camera. In this case, a right-eye image and a left-eye image may be generated from an image acquired by one virtual camera. In this embodiment, the technical idea of this disclosure is exemplified assuming that the virtual camera 14 includes two virtual cameras, and the roll axes of the two virtual cameras are synthesized so that the generated roll axis (w) is adapted to the roll axis (w) of the HMD 120.

[Controller]

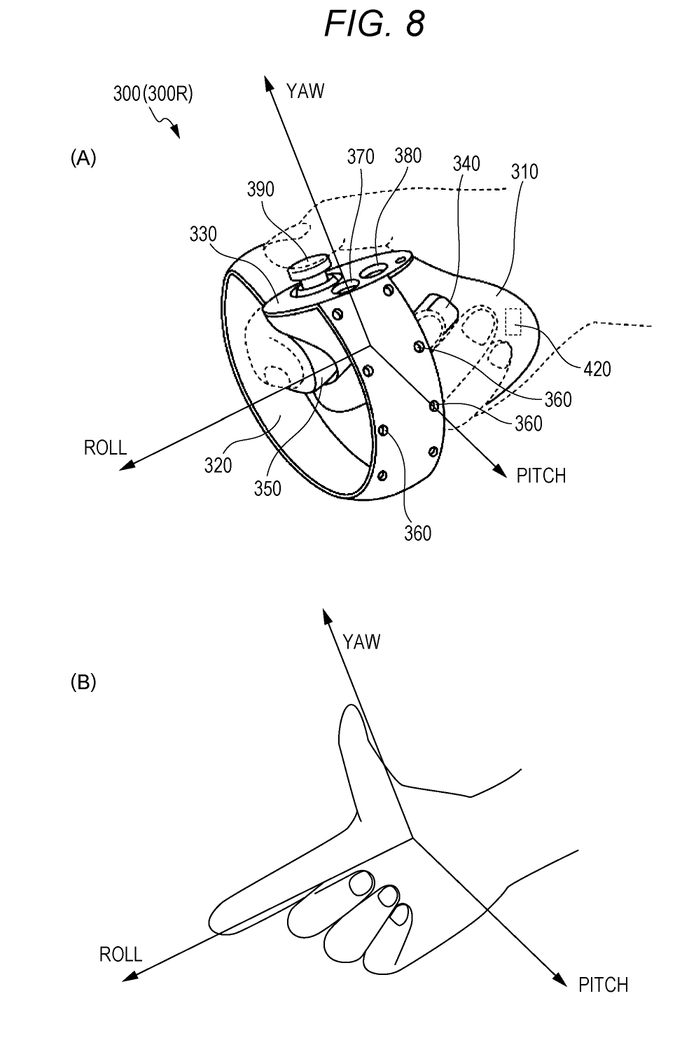

An example of the controller 300 is described with reference to FIGS. 8. FIGS. 8 are diagrams for illustrating a schematic configuration of the controller 300 in one embodiment of this disclosure.

As illustrated in FIGS. 8, in one aspect, the controller 300 may include a right controller 300R and a left controller (not shown) . The right controller 300R is operated by the right hand of the user 5. The left controller is operated by the left hand of the user 5. In one aspect, the right controller 300R and the left controller are symmetrically configured as separate devices. Therefore, the user 5 can freely move his or her right hand holding the right controller 300R and his or her left hand holding the left controller. In another aspect, the controller 300 may be an integrated controller configured to receive an operation performed by both hands. The right controller 300R is now described.

The right controller 300R includes a grip 310, a frame 320, and a top surface 330. The grip 310 is configured so as to be held by the right hand of the user 5. For example, the grip 310 may be held by the palm and three fingers (middle finger, ring finger, and small finger) of the right hand of the user 5.

The grip 310 includes buttons 340 and 350 and the motion sensor 420. The button 340 is arranged on a side surface of the grip 310, and receives an operation performed by the middle finger of the right hand. The button 350 is arranged on a front surface of the grip 310, and receives an operation performed by the index finger of the right hand. In one aspect, the buttons 340 and 350 are configured as trigger type buttons. The motion sensor 420 is built into the casing of the grip 310. When a motion of the user 5 can be detected from the surroundings of the user 5 by a camera or other device, it is not required for the grip 310 to include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 may be used to detect the position and the posture (inclination and direction) of each of the right controller 300R and the left controller. In the example illustrated in FIGS. 8, the infrared LEDs 360 are shown as being arranged in two rows, but the number of arrangement rows is not limited to that illustrated in FIGS. 8. The infrared LEDs 360 may be arranged in one row or in three or more rows.

The top surface 330 includes buttons 370 and 380 and an analog stick 390 . The buttons 370 and 380 are configured as push type buttons. The buttons 370 and 380 receive an operation performed by the thumb of the right hand of the user 5. In one aspect, the analog stick 390 receives an operation performed in any direction of 360 degrees from an initial position (neutral position) . The operation includes, for example, an operation for moving an object arranged in the virtual space 11.

In one aspect, each of the right controller 300R and the left controller includes a battery for driving the infrared ray LEDs 360 and other members. The battery includes, for example, a rechargeable battery, a button battery, a dry battery, but the battery is not limited thereto. In another aspect, the right controller 300R and the left controller may be connected to, for example, a USB interface of the computer 200. In this case, the right controller 300R and the left controller do not require a battery.

In FIG. 8A and FIG. 8B, for example, a yaw direction, a roll direction, and a pitch direction are defined with respect to the right hand of the user 5. A direction of extending the thumb, a direction of extending the index finger, and a direction perpendicular to a plane defined by the yaw-direction axis and the roll-direction axis when the user 5 extends his or her thumb and index finger are defined as the yaw direction, the roll direction, and the pitch direction, respectively.

[Hardware Configuration of Server]

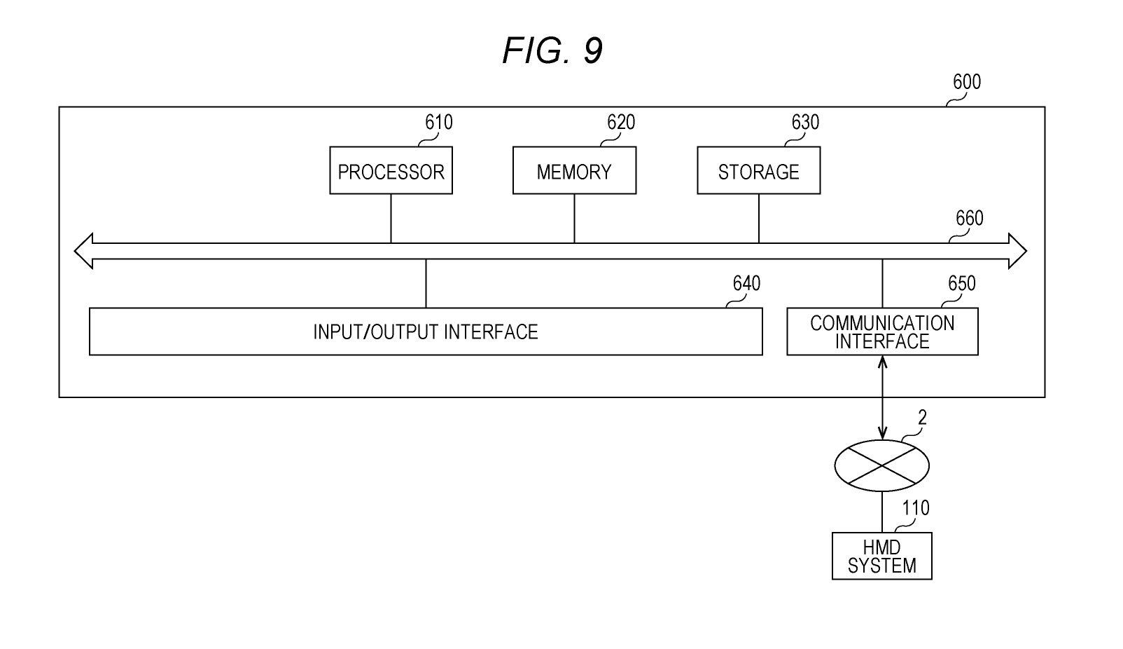

With reference to FIG. 9, the server 10 in this embodiment is described. FIG. 9 is a block diagram for illustrating an example of a hardware configuration of the server 600 in one embodiment of this disclosure. The server 600 includes, as primary components, a processor 610, a memory 620, a storage 630, an input/output interface 640, and a communication interface 650. Each component is connected to a bus 660.

The processor 610 executes a series of commands included in a program stored in the memory 620 or the storage 630 based on a signal transmitted to the server 600 or on satisfaction of a condition determined in advance. In one aspect, the processor 10 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In one aspect, the memory 620 is implemented as a random access memory (RAM) or other volatile memories.

The storage 630 permanently stores programs and data. The storage 630 is implemented as, for example, a read-only memory (ROM), a hard disk device, a flash memory, or other non-volatile storage devices. The programs stored in the storage 630 include programs for providing a virtual space in the HMD system 100, simulation programs, game programs, user authentication programs, and programs for implementing communication to/from other computers 200. The data stored in the storage 630 may include, for example, data and objects for defining the virtual space.

In another aspect, the storage 630 may be implemented as a removable storage device like a memory card. In another aspect, a configuration that uses programs and data stored in an external storage device may be used instead of the storage 630 built into the server 600. With such a configuration, for example, in a situation in which a plurality of HMD systems 100 are used as in an amusement facility, the programs and the data can be collectively updated.

The input/output interface 640 allows communication of signals to/from an input/output device. In one aspect, the input/output interface 640 is implemented with use of a USB, a DVI, an HDMI, or other terminals. The input/output interface 640 is not limited to ones described above.

The communication interface 650 is connected to the network 2 to communicate to/from the computer 200 connected to the network 2. In one aspect, the communication interface 650 is implemented as, for example, a LAN, other wired communication interfaces, Wi-Fi, Bluetooth, NFC, or other wireless communication interfaces. The communication interface 650 is not limited to ones described above.

In one aspect, the processor 610 accesses the storage 630 and loads one or more programs stored in the storage 630 to the memory 620 to execute a series of commands included in the program. The one or more programs may include, for example, an operating system of the server 610, an application program for providing a virtual space, and game software that can be executed in the virtual space. The processor 610 may transmit a signal for providing a virtual space to the HMD device 110 to the computer 200 via the input/output interface 640.

[Control Device of HMD]

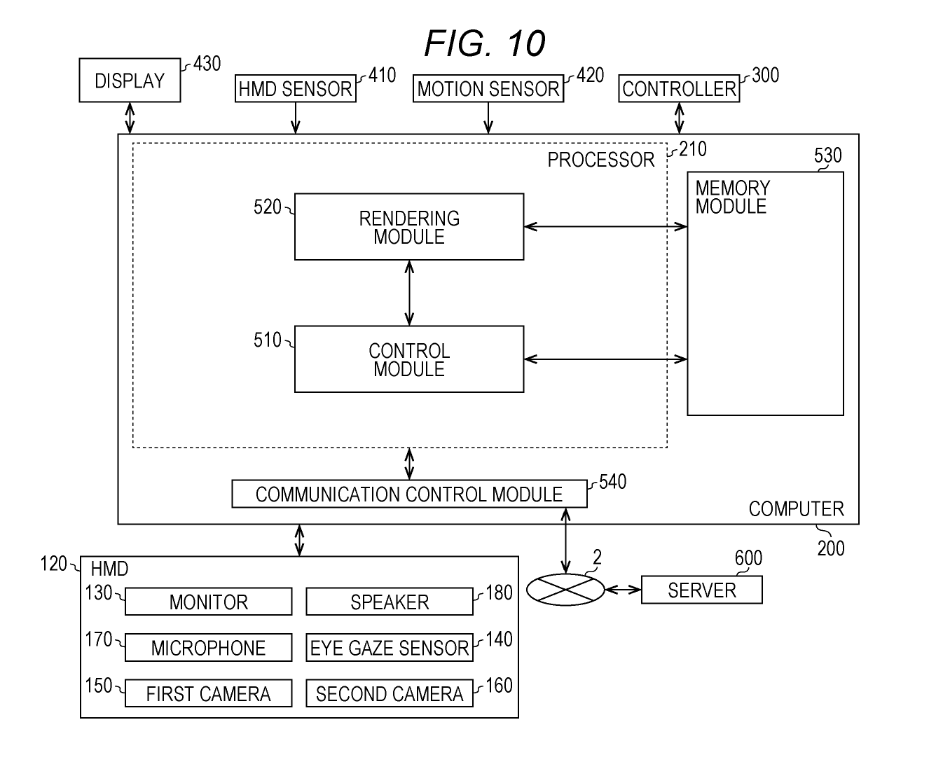

With reference to FIG. 10, the control device of the HMD 21 is described. According to one embodiment of this disclosure, the control device is implemented by the computer 200 having a known configuration. FIG. 10 is a block diagram for illustrating the computer 200 in one embodiment of this disclosure in terms of its module configuration.

As illustrated in FIG. 10, the computer 200 includes a control module 510, a rendering module 520, a memory module 530, and a communication control module 540. In one aspect, the control module 510 and the rendering module 520 are implemented by the processor 210. In another aspect, a plurality of processors 210 may actuate as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. The control module 510 may generate virtual space data by itself or acquire virtual space data from, for example, the server 600.

The control module 510 arranges objects in the virtual space 11 using object data representing objects. The object data is stored in, for example, the memory module 530. The control module 510 may generate virtual space data by itself or acquire object data from, for example, the server 600. The objects may include, for example, an avatar object of the user 5, character objects, operation objects, for example, a virtual hand to be operated by the controller 300, and forests, mountains, other landscapes, streetscapes, and animals to be arranged in accordance with the progression of the story of the game.

The control module 510 arranges an avatar object of the user 5 of another computer 200, which is connected via the network 2, in the virtual space 11. In one aspect, the control module 510 arranges an avatar object of the user 5 in the virtual space 11. In one aspect, the control module 510 arranges an avatar object simulating the user 5 in the virtual space 11 based on an image including the user 5. In another aspect, the control module 510 arranges an avatar object in the virtual space 2, which is selected by the user 5 from among a plurality of types of avatar objects (e.g., objects simulating animals or objects of deformed humans).

The control module 510 identifies an inclination of the HMD 120 based on output of the HMD sensor 410. In another aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In another aspect, the control module 510 may be configured to transmit line-of-sight information representing the line of sight of the user 5 to the server 600. In such a case, the control module 510 may calculate the point-of-view position based on the line-of-sight information received by the server 600.

The control module 510 reflects a motion of the HMD 120, which is detected by the HMD sensor 410, in an avatar object. For example, the control module 510 detects inclination of the HMD 120, and arranges the avatar object in an inclined manner. The control module 510 reflects the detected motion of face parts in a face of the avatar object arranged in the virtual space 11. The control module 510 receives line-of-sight information of another user 5 from the server 600, and reflects the line-of-sight information in the line of sight of the avatar object of another user 5. In one aspect, the control module 510 reflects a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In one aspect, the operation object may include, for example, a hand object serving as a virtual hand corresponding to a hand of the user 5. In one aspect, the control module 510 moves the hand object in the virtual space 11 so that the hand object moves in association with a motion of the hand of the user 5 in the real space based on output of the motion sensor 420. In one aspect, the operation object may correspond to a hand part of an avatar object.

When one object arranged in the virtual space 11 collides with another object, the control module 510 detects the collision. The control module 510 can detect, for example, a timing at which a collision area of one object and a collision area of another object have touched with each other, and performs predetermined processing when the timing is detected. The control module 510 can detect a timing at which an object and another object, which have been in contact with each other, have become away from each other, and performs predetermined processing when the timing is detected. The control module 510 can detect a state in which an object and another object are in contact with each other. For example, when an operation object touches with another object, the control module 510 detects the fact that the operation object has touched with another object, and performs predetermined processing.

In one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 510 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs voices (utterances) corresponding to the voice data from the speaker 180.

The memory module 530 holds data to be used to provide the virtual space 11 to the user 5 by the computer 200. In one aspect, the memory module 530 holds space information, object information, and user information.

The space information holds one or more templates defined to provide the virtual space 11.

The object information stores a plurality of panorama images 13 forming the virtual space 11 and object data for arranging objects in the virtual space 11. The panorama image 13 may contain a still image and a moving image. The panorama image 13 may contain an image in a non-real space and an image in the real space. An example of the image in a non-real space is an image generated by computer graphics.

The user information stores a user ID for identifying the user 5. The user ID may be, for example, an internet protocol (IP) address or a media access control (MAC) address set to the computer 200 used by the user. In another aspect, the user ID may be set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

The communication control module 540 may communicate to/from the server 600 or other information communication devices via the network 2.

In one aspect, the control module 510 and the rendering module 520 may be implemented with use of, for example, Unity (trademark) provided by Unity Technologies. In another aspect, the control module 510 and the rendering module 520 may also be implemented by combining the circuit elements for implementing each step of processing.

The processing performed in the computer 200 is implemented by hardware and software executed by the processor 410. The software may be stored in advance on a hard disk or other memory module 530. The software may also be stored on a CD-ROM or other computer-readable non-volatile data recording media, and distributed as a program product. The software may also be provided as a program product that can be downloaded by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

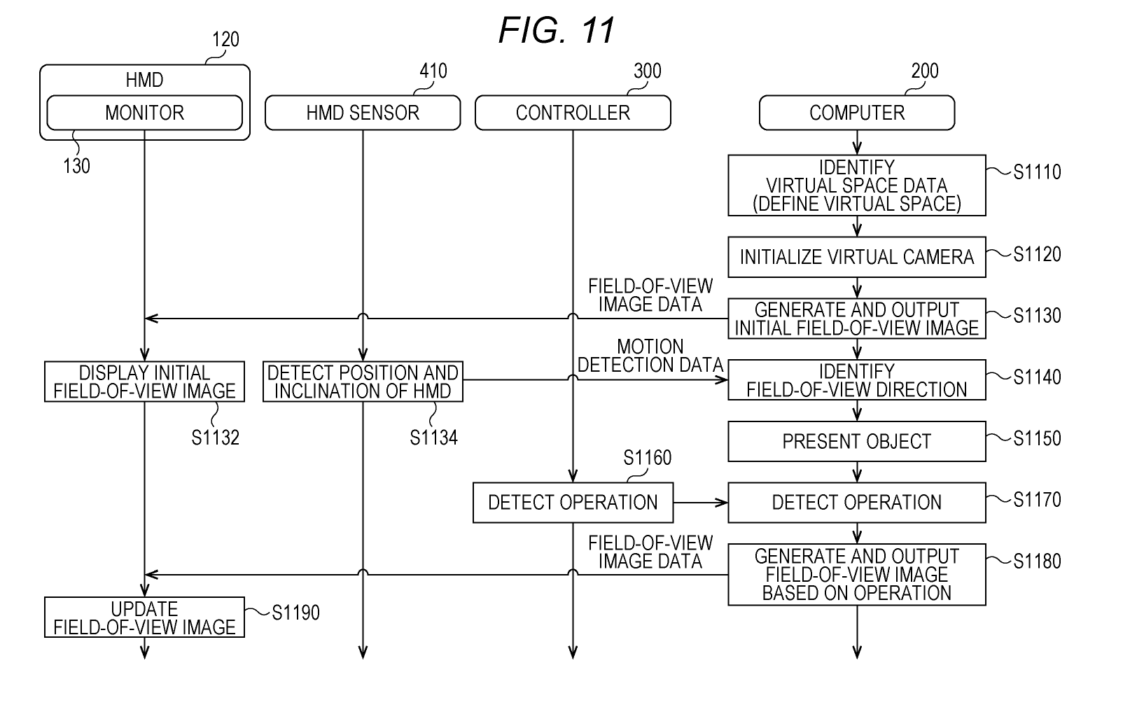

With reference to FIG. 11, the control structure of the HMD set 110 is described. FIG. 11 is a sequence chart for illustrating a part of processing to be executed by the HMD system 100 in one embodiment of this disclosure.

As illustrated in FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In another aspect, an operation of the controller 300 by the user 5 may be detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

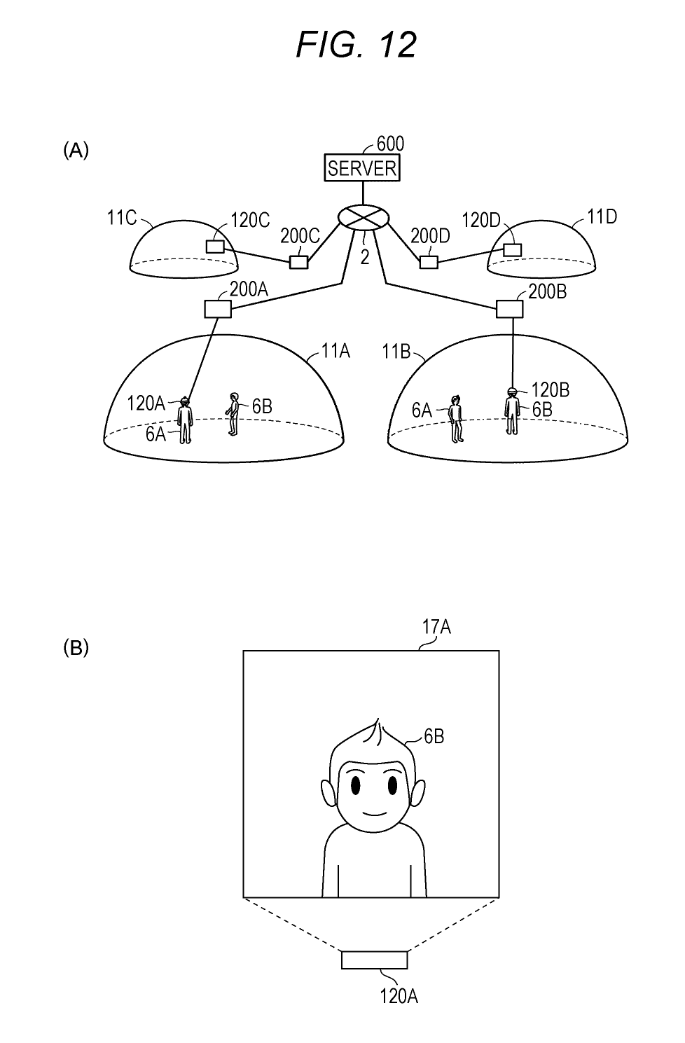

With reference to FIG. 12 (A) and FIG. 12 (B), an avatar object in this embodiment is described. FIG. 12(A) and FIG. 12(B) are diagrams for illustrating avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12 (A) is a schematic diagram for illustrating a situation in which each HMD 120 provides the user 5 with the virtual space 11. Computers 200A to 200D provide the users 5A to 5D with virtual spaces 11A to 11D via HMDs 120A to 120D, respectively. In the example illustrated in FIG. 12 (A), the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, this illustration is only for the sake of simplicity of description, and those objects do not wear the HMD 120 in actuality.

In one aspect, the processor 210A may arrange a virtual camera 14A for photographing a field-of-view region 17A of the user 5A at the position of eyes of the avatar object 6A.

FIG. 12(B) is a diagram for illustrating the field-of-view region 17A of the user 5A in FIG. 12(A). The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not particularly illustrated in FIG. 12B, the avatar object 6A of the user 5A is displayed in the field-of-view image of the user 5B.

Under the state of FIG. 12(B), the user 5A can communicate to/from the user 5B via the virtual space 11A through conversation. More specifically, voices of the user 5A acquired by a microphone 170A are transmitted to the HMD17120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A reflects an operation by the user 5B (operation of HMD 120B and operation of controller 300B) in the avatar object 6B arranged in the virtual space 11A. With this, the user 5A can recognize the operation by the user 5B through the avatar object 6B.

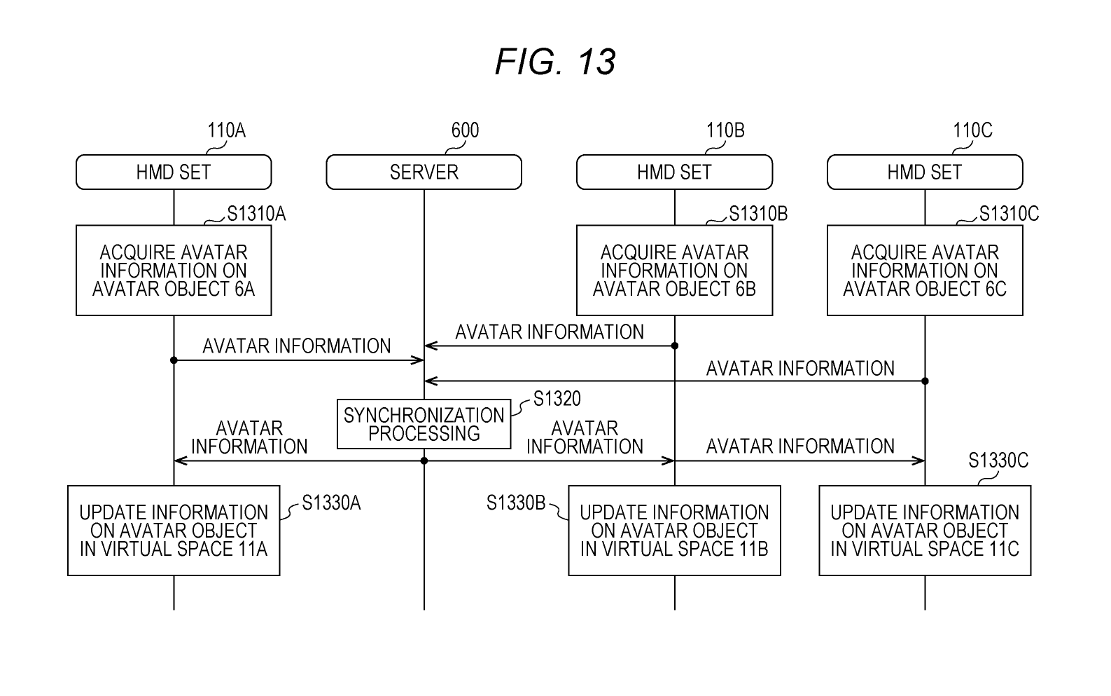

FIG. 13 is a sequence chart for illustrating a part of processing to be executed by the HMD system 100 in this embodiment. In FIG. 13, although the HMD set 110D is not illustrated, the HMD set 110D operates in the same manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. The avatar information may contain information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210B of the HMD set 110B acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD11020C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 540. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Detailed Configuration of Modules]

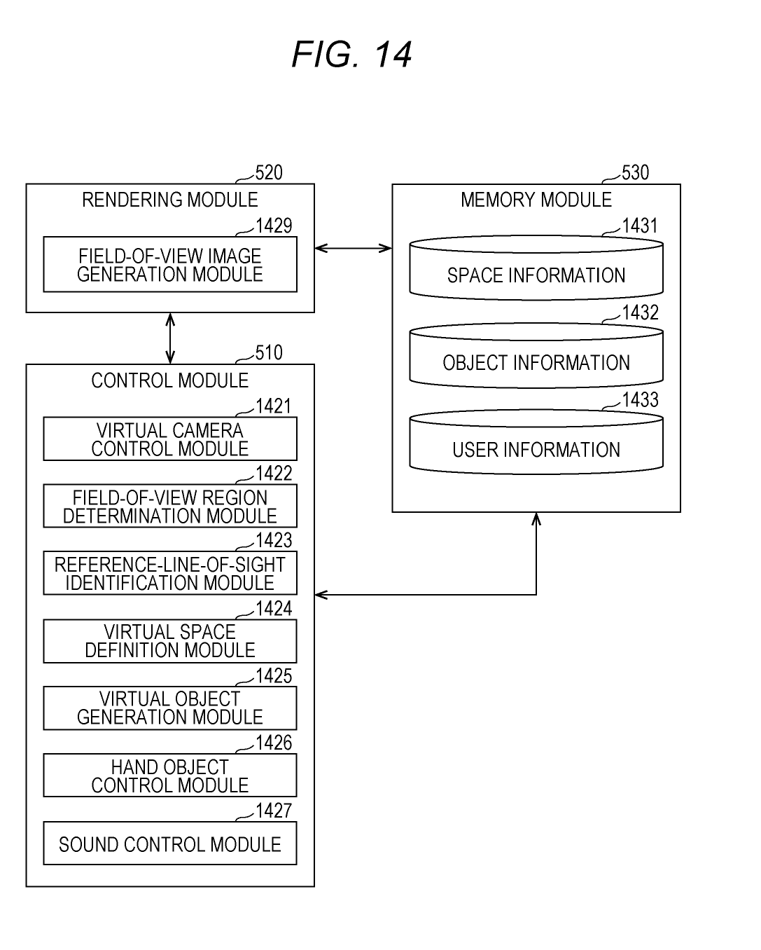

Now, referring to FIG. 14, a description is given of a detailed configuration of modules of the computer 200. FIG. 14 is a block diagram for illustrating the detailed configuration of modules of the computer 200 according to one embodiment of this disclosure.

As illustrated in FIG. 14, the control module 510 includes a virtual camera control module 1421, a field-of-view region determination module 1422, a reference-line-of-sight identification module 1423, a virtual space definition module 1424, a virtual object generation module 1425, a hand object control module 1426, and a sound control module 1427. The rendering module 520 includes a field-of-view image generation module 1429. The memory module 530 stores space information 1431, object information 1432, user information 1433, and face information 1434.

In one aspect, the control module 510 controls display of an image on the monitor 130 of the HMD 120. The virtual camera control module 1421 arranges the virtual camera 14 in the virtual space 11, and controls, for example, the behavior and direction of the virtual camera 14. The field-of-view region determination module 1422 defines the field-of-view region 15 in accordance with the direction of the head of the user 5 wearing the HMD 120. The field-of-view image generation module 1429 generates data (also referred to as “field-of-view image data”) on a field-of-view image to be displayed on the monitor 130 based on the determined field-of-view region 15. Further, the field-of-view image generation module 1429 generates field-of-view image data based on data received from the control module 510. The field-of-view image data generated by the field-of-view image generation module 1429 is output to the HMD 120 by the communication control module 540. The reference-line-of-sight identification module 1423 identifies the line of sight of the user 5 based on the signal from the eye gaze sensor 140.

The control module 510 controls the virtual space 11 to be provided to the user 5. The virtual space definition module 1424 generates virtual space data representing the virtual space 11, to thereby define the virtual space 11 in the HMD set 110.

The virtual object generation module 1425 generates data on objects to be arranged in the virtual space 11. The objects may include, for example, a different avatar object and a virtual vehicle . Data generated by the virtual object generation module 1425 is output to the field-of-view image generation module 1429.

The hand object control module 1426 arranges a hand object in the virtual space 11. The hand object corresponds to, for example, a right hand or a left hand of the user 5 holding the controller 300. In one aspect, the hand object control module 1426 generates data for arranging a hand object corresponding to the right hand or the left hand in the virtual space 11. The hand object control module 1426 generates data for moving the hand object in accordance with operation of the controller 300 by the user 5. The data generated by the hand object control module 1426 is output to the field-of-view image generation module 1429.

In another aspect, when motion (e.g., motion of left hand, right hand, left foot, right foot, or head) of a part of the body of the user 5 is associated with the controller 300, the control module 510 generates data for arranging a partial object, which corresponds to a part of the body of the user 5, in the virtual space 11. When the user 5 operates the controller 300 using a part of the body, the control module 510 generates data for moving the partial object. Those pieces of data are output to the field-of-view image generation module 1429.

When the user 5 uses the microphone 170 to give an utterance and the sound control module 1427 detects the utterance from the HMD 120, the sound control module 1427 identifies the computer 200 to which the sound data corresponding to the utterance is to be transmitted. The sound data is transmitted to the computer 200 identified by the sound control module 1427. When the sound control module 1427 receives sound data from the computer 200 of another user via the network 2, the sound control module 1427 outputs from the speaker 180 a sound (utterance) corresponding to the sound data.

The space information 1431 stores one or more templates that are defined to provide the virtual space 11.

The object information 1432 stores content to be reproduced in the virtual space 11 and information for arranging an object to be used in the content. The content may include, for example, game content and content representing landscapes that resemble those of the real society. Further, the object information 1431 includes data for arranging, in the virtual space 11, a hand object corresponding to the hand of the user 5 operating the controller 300, data for arranging an avatar object of each user in the virtual space 11, and data for arranging other objects, for example, a virtual vehicle, in the virtual space 11.

The user information 1433 stores, for example, a program for causing the computer 200 to function as a control device for the HMD set 110 and an application program that uses each piece of content stored in the object information 1432. The data and programs stored in the memory module 520 are input by the user 5 of the HMD 120. Alternatively, the processor 210 downloads programs or data from a computer (e.g., server 600) that is managed by a business operator providing the content, and stores the downloaded programs or data in the memory module 520.

[Interaction between Users on Network]

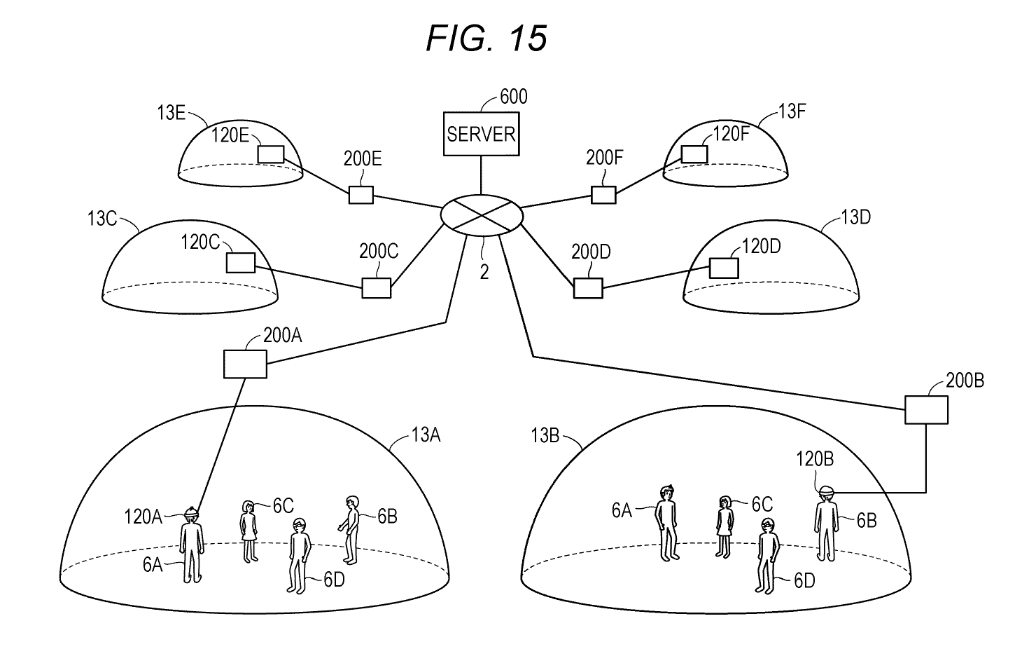

Referring to FIG. 15, a description is given of interaction between users in the network 2. FIG. 15 is a diagram for conceptually illustrating one mode of representation of the respective virtual spaces 11 presented by the plurality of computers 200.

As illustrated in FIG. 15, the computers 200A to 200F can each communicate to/from the server 600 via the network 2. The computers 200A to 200F provide panorama images 13A to 13F in the corresponding HMDs 120A to 120F. The panorama images 13A to 13F present avatar objects 6A to 6D corresponding to the users of the respective computers 200A to 200F.

For example, the avatar object 6A corresponds to the user 5A of the HMD 120A. Therefore, in the panorama image 13A visually recognized by the user 5 of the HMD 120A, avatar objects 6B to 6D are presented as different avatar objects corresponding to different users. Meanwhile, the avatar object 6B corresponds to the user 5B of the HMD 120B. Therefore, in the panorama image 13B visually recognized by the user 5B of the HMD 120B, the avatar objects 6A to 6C are presented as different avatar objects corresponding to different users.

The HMDs 120A to 120F transmit pieces of motion detection data corresponding to the positions and inclinations of the respective users to the server 600. The server 600 receives the motion detection data from each of the HMDs 120A to 120F for transmission to the other HMDs 120 in the network 2. The other HMDs 120 change the positions and inclinations of other avatar objects based on those pieces of motion detection data.

Each of the HMDs 120A to 120F transmits to the server 600 data indicating a detection result of the line-of-sight direction of the user 5, which is obtained by the eye gaze sensor 140. The server 600 transmits detection data on the line-of-sight direction received from each of the HMDs 120A to 120F to the other HMDs 120 within the network 2. Each of the other HMDs 120 changes the line of sight of the different avatar object based on the received detection data.

The HMDs 120A to 120F transmit pieces of sound data corresponding to the utterance of the respective users to the server 600. The server 600 receives those pieces of sound data from the HMDs 120A to 120F for transmission to the other HMDs 120 in the network 2. The other HMDs 120 change how much the mouths of other avatar objects open based on those pieces of sound data. The other HMDs 120 output sounds that are based on the sound data from the speaker 180.

In this manner, motion or utterance of a certain user 5 in the real space changes the position or facial expression of an avatar object corresponding to the user 5 in the virtual space 11. Then, through such motion or utterance of another user in the real space as to respond to this change, the position or facial expression of an avatar object corresponding to another user is changed in the virtual space 11. In this manner, interaction between users wearing the different HMDs 120 is implemented in the virtual space 11 by using communication in the network 2.

[Control Structure of HMD System]

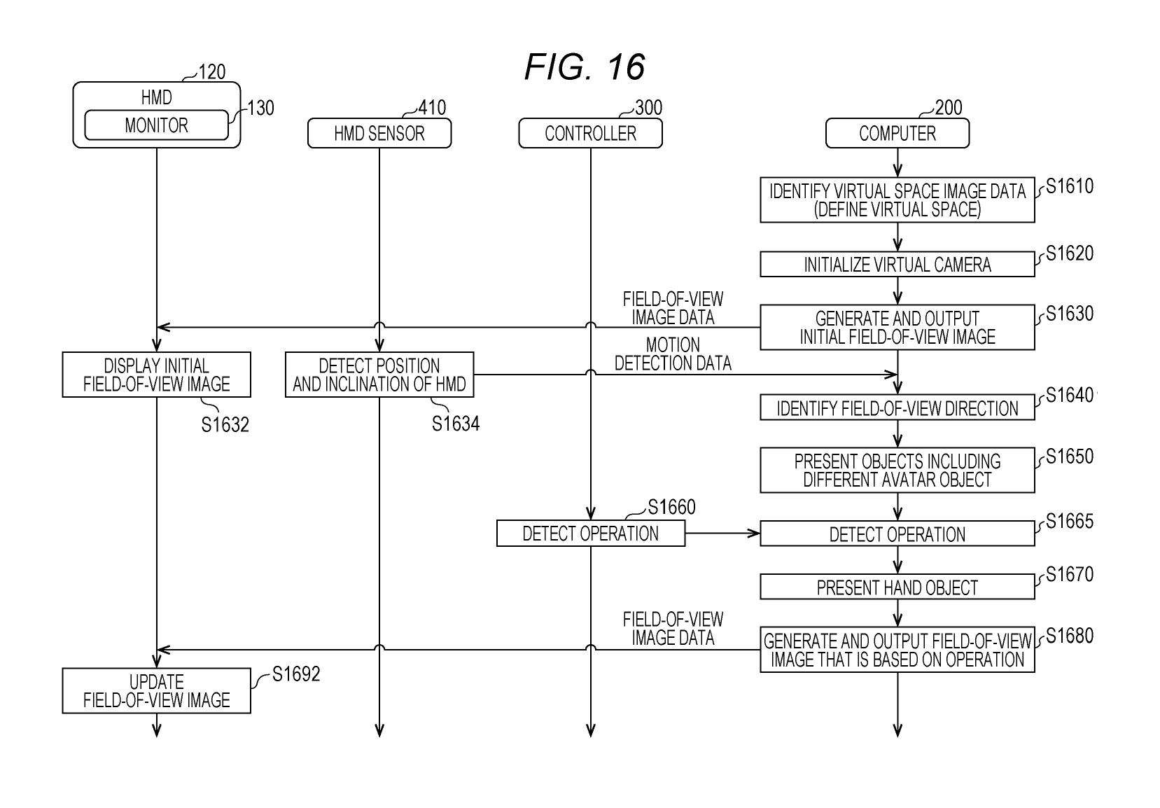

Referring to FIG. 16, a description is given of the control structure of the HMD set 110. FIG. 16 is a sequence chart for illustrating a part of processing to be executed by the HMD set 110 in one embodiment of this disclosure.

As illustrated in FIG. 16, in Step S1610, the processor 210 of the computer 200 serves as the virtual space definition module 1424 to identify virtual space image data and define the virtual space.

In Step S1620, the processor 210 initializes the virtual camera 14. For example, in a work area of the memory, the processor 210 arranges the virtual camera 14 at the center defined in advance in the virtual space 11, and matches the line of sight of the virtual camera 14 with the direction in which the user 5 faces.

In Step S1630, the processor 210 serves as the field-of-view image generation module 1429 to generate field-of-view image data for displaying an initial field-of-view image. The generated field-of-view image data is output to the HMD 120 by the communication control module 540.

In Step S1632, the monitor 130 of the HMD 120 displays the field-of-view image based on the field-of-view image data received from the computer 200. The user 5 wearing the HMD 120 may recognize the virtual space 11 through visual recognition of the field-of-view image.

In Step S1634, the HMD sensor 410 detects the position and the inclination of the HMD 120 based on a plurality of infrared rays emitted from the HMD 120. The detection results are output to the computer 200 as motion detection data.

In Step S1640, the processor 210 identifies a field-of-view direction of the user 5 wearing the HMD 120 based on the position and inclination of the HMD 120, which are included in the motion detection data.

In Step S1650, the processor 210 executes an application program, and presents objects in the virtual space 11 based on a command included in the application program. The objects to be presented at this time include a different avatar object.

In Step S1660, the controller 300 detects operation of the user 5 based on a signal output from the motion sensor 420, and outputs detection data representing the detected operation to the computer 200. In another aspect, operation of the controller 300 by the user 5 may be detected based on an image captured by a camera arranged around the user 5.

In Step S1665, the processor 210 detects operation of the controller 300 by the user 5 based on the detection data acquired from the controller 300.

In Step S1670, the processor 210 generates field-of-view image data for presenting the hand object in the virtual space 11.

In Step S1680, the processor 210 generates field-of-view image data based on operation of the controller 300 by the user 5. The generated field-of-view data is output to the HMD 120 by the communication control module 540.

In Step S1692, the HMD 120 updates a field-of-view image based on the received view field image data, and displays the updated view field image on the monitor 130.

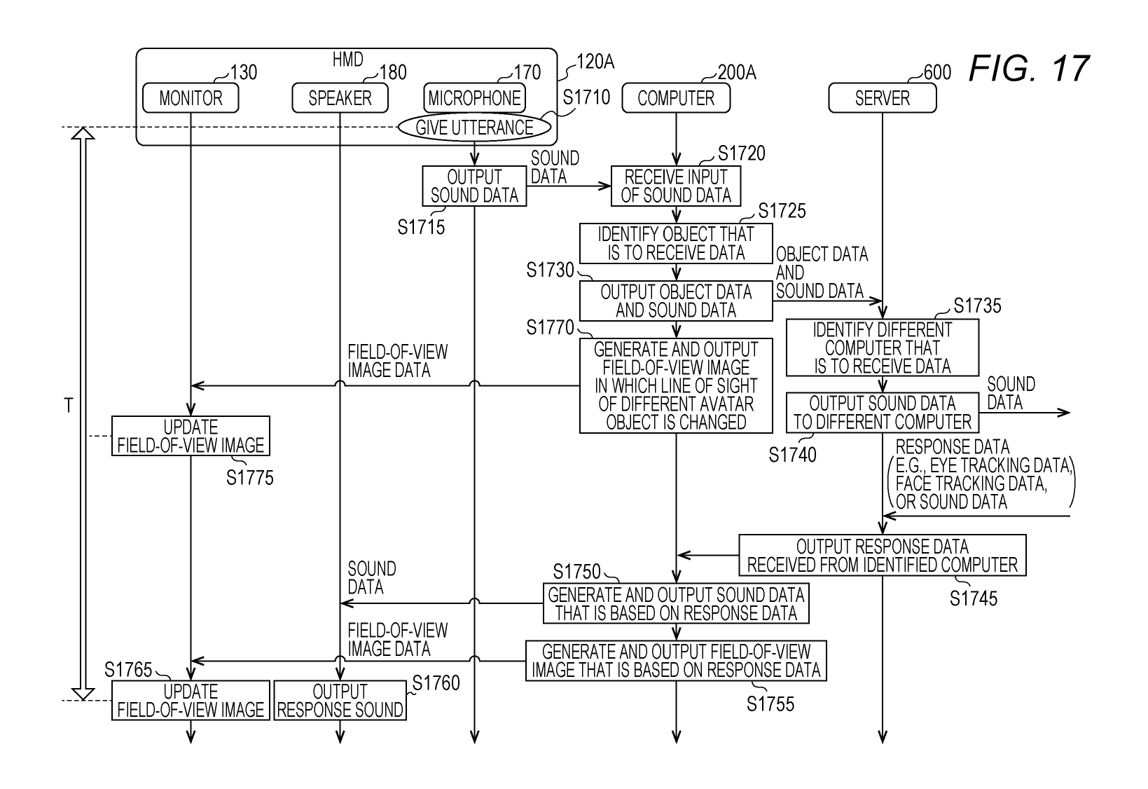

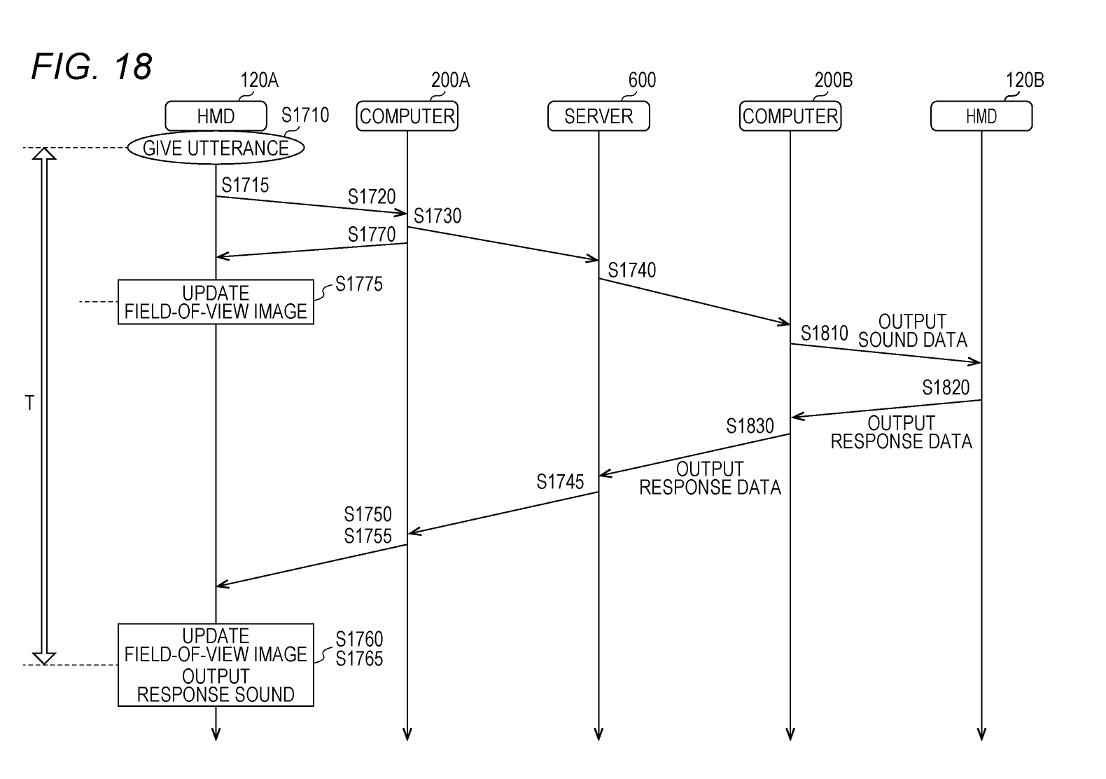

Referring to FIG. 17 and FIG. 18, a description is given of the control structure of the HMD system 100 in one embodiment of this disclosure. FIG. 17 is a sequence chart for illustrating a part of detailed processing to be executed in the HMD system 100 in one embodiment of this disclosure. FIG. 18 is a sequence chart for illustrating a part of communication between the plurality of computers 200. In FIG. 17 and FIG. 18, there is illustrated an example of communication to be performed between the computer 200A connected to the HMD 120A and the computer 200B connected to the HMD 120B. Processing to be executed by the computer 200A or the computer 200B is executed by the processor 210 included in each of the computers 200.

As illustrated in FIG. 17, in Step S1710, when the user 5 of the HMD 120A uses the microphone 170 to give an utterance, sound data corresponding to the utterance is output to the computer 200A in Step S1715. In Step S1720, the computer 200A receives input of the sound data.

In Step S1725, the computer 200A identifies a different avatar object that is to receive the sound data. In Step S1730, the computer 200A outputs to the server 600 object data corresponding to the identified different avatar object and the sound data.

In Step S1735, the server 600 identifies the computer 200B, which is to receive the sound data, based on the received object data. In Step S1740, the server 600 outputs the sound data to the identified computer 200B.

As illustrated in FIG. 18, in Step S1810, the computer 200B outputs to the HMD 120B the sound data received from the server 600. In this step, the speaker 180B of the HMD 120B outputs a sound that is based on the sound data. When the user of the HMD 120B hears the sound and then performs an action to respond to the sound, in Step S1820, response data corresponding to the action is output to the computer 200B. Examples of the response action performed by the user of the HMD 120B include giving of an utterance, movement of the line of sight, and movement of the face. When the response action is giving of an utterance, the response data includes sound data corresponding to the utterance. When the response action is movement of the line of sight, the response data includes eye tracking data indicating a result of tracking the line of sight. When the response action is movement of the face, the response data includes face tracking data indicating a result of tracking a motion of the face. In Step S1830, the computer 200B outputs the received response data to the server 600.

As illustrated in FIG. 17, in Step S1745, the server 600 outputs the received response data to the computer 200A.

In one aspect, when the response data is sound data, in Step S1750, the computer 200A generates sound data that is based on the response data, and outputs the sound data to the HMD 120A.

In Step S1760, the HMD 120A outputs from the speaker 170 a sound that is based on the received sound data.

In Step S1755, the computer 200A generates a field-of-view image that is based on the response data, and outputs to the HMD 120A field-of-view image data corresponding to the field-of-view image. For example, in one aspect, when the response data is sound data, the computer 200A generates a field-of-view image in which the mouth of the different avatar object corresponding to the user of the computer 200B is moved. In another aspect, when the response data is eye tracking data, the computer 200A generates afield-of-view image in which the line of sight of the different avatar object corresponding to the user of the computer 200B is moved. In still another aspect, when the response data is face tracking data, the computer 200A generates a field-of-view image in which the face of the different avatar object corresponding to the user of the computer 200B is moved.

In Step S1765, the HMD 120A updates the field-of-view image based on the received field-of-view image data, and displays the updated field-of-view image on the monitor 130.

As illustrated in FIG. 17 and FIG. 18, a time T from when the user of the computer 200A gives an utterance to when the different avatar object corresponding to the user of the computer 200B moves in response to the utterance depends at least on a period of time of communication between the computer 200A and the computer 200B.

Thus, in Step S1770, which is executed within the time T, the computer 200A generates a field-of-view image in which the line of sight of the different avatar object is changed, and outputs field-of-view image data corresponding to the field-of-view image to the HMD 120A. In Step S1775, the HMD 120A updates the field-of-view image based on the received field-of-view image data, and displays the updated field-of-view image on the monitor 130. In this manner, the line of sight of the different avatar object is changed within the time T.

[Control Structure of Computer]

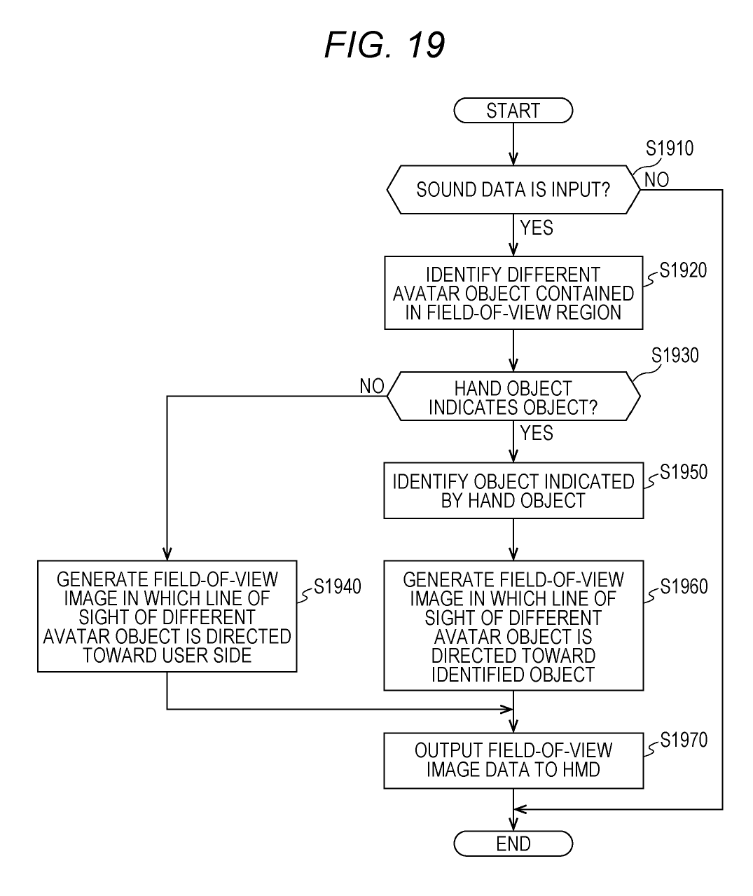

Referring to FIG. 19, a description is given of the control structure of the computer 200. FIG. 19 is a flowchart for illustrating detailed processing to be executed by the processor 210 of the computer 200 in one aspect of one embodiment of this disclosure.

As illustrated in FIG. 19, in Step S1910, the processor 210 determines whether or not input of the sound data corresponding to the utterance of the user is received from the HMD 120.

When the input of the sound data is not received from the HMD 120 (NO in Step S1910), the processor 210 ends the processing.

Meanwhile, when the input of the sound data is received from the HMD 120 (YES in Step S1910), in Step S1920, the processor 210 identifies a different avatar object contained in the field-of-view region 15.

In Step S1930, the processor 210 determines whether or not the hand object indicates an object. For example, as illustrated in FIG. 8B, when the direction in which the index finger extends is defined as the roll direction, the processor 210 determines, based on detection data on a motion of the hand of the user 5 obtained by the motion sensor 420, whether or not an object exists on a line extending from the axis of the roll direction.

When the hand object does not indicate any object (NO in Step S1930), in Step S1940, the processor 210 generates a field-of-view image in which the line of sight of the different avatar object is directed toward the user 5 side (virtual camera 14 side).

In Step S1970, the processor 210 outputs to the HMD 120 field-of-view image data corresponding to the field-of-view image generated in Step S1940, and ends the processing.

Meanwhile, when the hand object indicates an object (YES in Step S1930), in Step S1950, the processor 210 identifies the object indicated by the hand object.

In Step S1960, the processor 210 generates a field-of-view image in which the line of sight of the different avatar object is directed toward the object identified in Step S1930.

In Step S1970, the processor 210 outputs to the HMD 120 field-of-view image data corresponding to the field-of-view image generated in Step S1960, and ends the processing.

As one mode of the processing described above, the mode of executing each step by the computer 200 is exemplified. However, when the HMD 120 includes a processor, the processor may execute each processing step.

[Presentation of Object in Virtual Space]

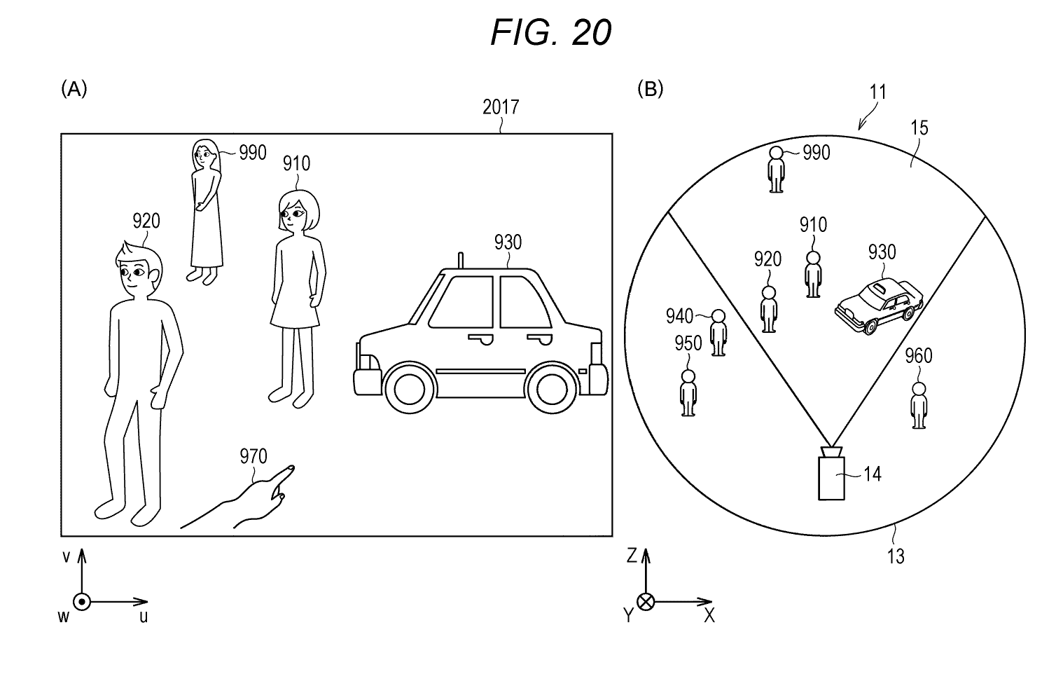

Referring to FIG. 20A and FIG. 20B, a description is given of presentation of an object in the virtual space 11. FIG. 20A and FIG. 20B are diagrams for illustrating an example of presentation of an object in the virtual space 11 in one embodiment of this disclosure. FIG. 20A is an illustration of a field-of-view image 2017 displayed on the monitor 130 of the HMD 120. The field-of-view image 2017 is an image to be provided by the HMD 120 to the user 5. FIG. 20B is an illustration of the field-of-view region 15, which is a part of the virtual space 11 that is captured by the virtual camera 14. The field-of-view region 15 is a region corresponding to a part of the virtual space 11 visually recognizable by the user 5 that is captured by the virtual camera 14 corresponding to the user 5. Three axes of the visual-field coordinate system illustrated in FIG. 20A (u axis, v axis, and w axis) correspond to respective three axes of the global coordinate system illustrated in FIG. 20B (x axis corresponding to the horizontal direction, y axis corresponding to the vertical direction, and z axis corresponding to the front-rear direction).

As illustrated in FIG. 20B, in one aspect, in the panorama image 13, there are presented different avatar objects 910, 920, 940, 950, 960, and 990 corresponding to respective six different users, a taxi object 930 representing a taxi as a virtual vehicle existing in the virtual space 11, and other objects are presented. Of those objects, the different avatar objects 910, 920, and 990 and the taxi object 930 are presented in the field-of-view region 15 captured by the virtual camera 14.

As illustrated in FIG. 20A, the field-of-view image 2017 corresponds to an image of the field-of-view region 15 captured by the virtual camera 14. In one aspect, the different avatar objects 910, 920, and 990, the taxi object 930, and other objects are presented in the field-of-view image 2017. When the user 5 operates the controller 300, a hand object 970 is further presented in the field-of-view image 2017.

[Change in Object Presented in Virtual Space]

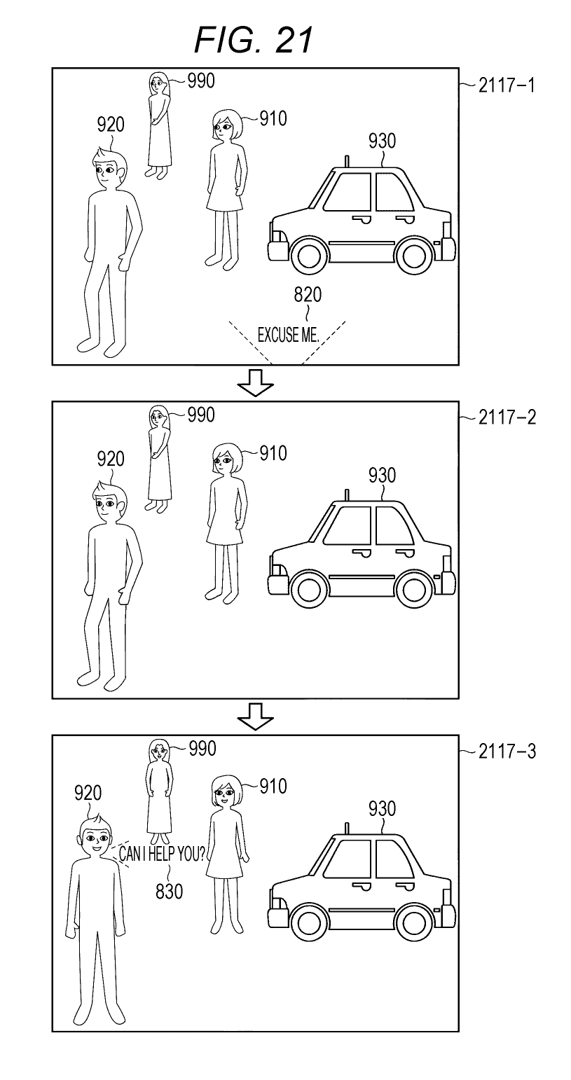

Referring to FIG. 21, a description is given of change in object presented in the virtual space 11. FIG. 21 is a diagram for illustrating an example of change in object presented in the virtual space 11 in one embodiment of this disclosure. In FIG. 21, field-of-view images 2117-1 to 2117-3 displayed on the monitor 130 of the HMD 120 are illustrated. The field-of-view images 2117-1 to 2117-3 are images provided by the HMD 120 to the user 5.

As illustrated in FIG. 21, in one aspect, in each of the field-of-view images 2117-1 to 2117-3, the different avatar objects 910, 920, and 990 corresponding to respective different users, and the taxi object 930 are presented as objects contained in the field-of-view region 15. In one aspect, when the user 5 uses the microphone 170 to give an utterance, a character image (“Excuse me.”) 820 corresponding to the utterance is presented in the field-of-view image 2117-1. In another aspect, even when the user 5 uses the microphone 170 to give an utterance, the character image 820 corresponding to the utterance may not be presented in the field-of-view image 2117-1. Sound data corresponding to the utterance of the user 5 is output to the computers 200 of the different users corresponding to all the different avatar objects 910, 920, and 990 contained in the field-of-view region 15.

In the field-of-view image 2117-1, a line of sight of each of the different avatar objects 910, 920, and 990 is directed toward a left side of the field-of-view image 2117-1. In the field-of-view image 2117-2 obtained after the user 5 has given the utterance, the line of sight of each of the different avatar objects 910, 920, and 990 is directed toward the side of the user 5, who has given the utterance. The update from the field-of-view image 2117-1 to the field-of-view image 2117-2 is based on the processing of Step S1770 by the processor 210, which is illustrated in FIG. 17 and FIG. 18, and the processing of Step S1940 by the processor 210, which is illustrated in FIG. 19.

When the computer 200 of the user 5 receives response data from the computer 200 of any one of the different users, the computer 200 of the user 5 updates the field-of-view image 2117-2 to the field-of-view image 2117-3 based on the response data. The update from the field-of-view image 2117-2 to the field-of-view image 2117-3 is based on the processing of Step S1755 by the processor 210, which is illustrated in FIG. 17 and FIG. 18. In the field-of-view image 2117-3, each of the bodies of the different avatar objects 910, 920, and 990 is directed toward the user 5 side. In one aspect, the different avatar object 920 opens the mouth in the field-of-view image 2117-3. In the field-of-view image 2117-3, a character image (“Can I help you?”) 830 based on an utterance of a different user corresponding to the different avatar object 920 is presented. In another aspect, the mouth of the different avatar object 920 opens, but the character image (“Can I help you?”) 830 based on the utterance of the different user corresponding to the different avatar object 920 may not be presented in the field-of-view image 2117-3.

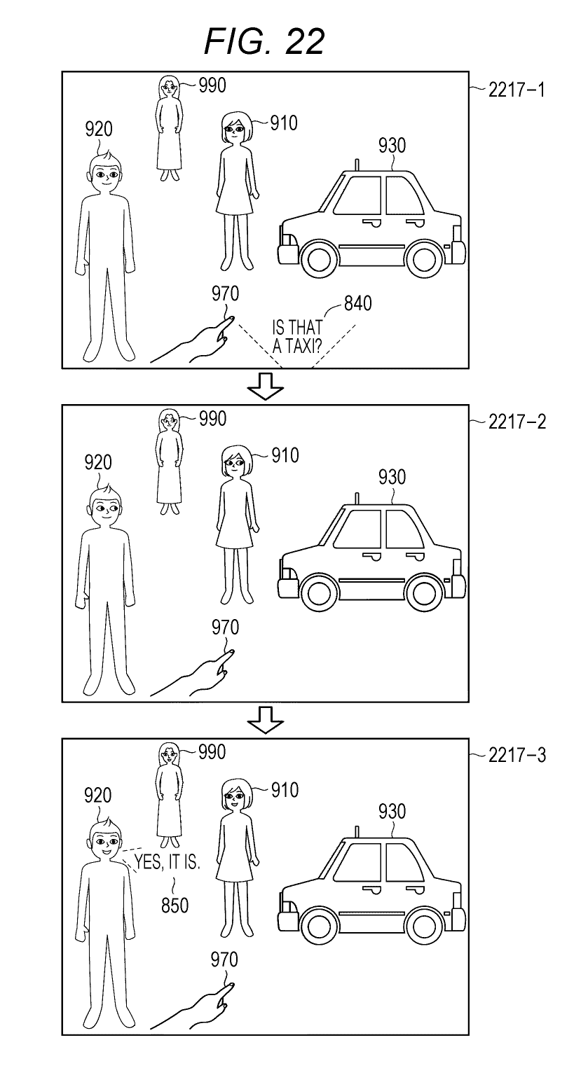

Referring to FIG. 22, a description is given of field-of-view images 2217-1 to 2217-3, which are displayed on the monitor 130 after the field-of-view image 2117-3 illustrated in FIG. 21 is displayed. FIG. 22 is a diagram for illustrating an example of change in object presented in the virtual space 11 in one embodiment of this disclosure. In FIG. 22, the field-of-view images 2217-1 to 2217-3 displayed on the monitor 130 of the HMD 120 are illustrated. The field-of-view images 2217-1 to 2217-3 are images to be visually recognized by the user 5 wearing the HMD 120.

As illustrated in FIG. 22, in each of the field-of-view images 2217-1 to 2217-3, the different avatar objects 910, 920, and 990 corresponding to respective different users, and the taxi object 930 are presented as objects contained in the field-of-view region 15. When the user 5 uses the microphone 170 to give an utterance, a character image (“Is that a taxi?”) 840 corresponding to the utterance is presented in the field-of-view image 2217-1. In another aspect, even when the user 5 uses the microphone 170 to give an utterance, the character image 840 corresponding to the utterance may not be presented in the field-of-view image 2217-1. Further, when the user 5 indicates the taxi object 930 through the operation of the controller 300, the direction indicated by the hand object 970 is changed to a direction toward the taxi object 930.

In the field-of-view image 2217-1, each of the lines of sight of the different avatar objects 910, 920, and 990 is directed toward the user 5 side. In one aspect, in the field-of-view image 2217-2 obtained after the user 5 has given the utterance, each of the lines of sight of the different avatar objects 910, 920, and 990 is directed toward the taxi object 930, which is indicated by the hand object 970. The update from the field-of-view image 2217-1 to the field-of-view image 2217-2 is based on the processing of Step S1770 by the processor 210, which is illustrated in FIG. 17 and FIG. 18, and the processing of Step S1960 by the processor 210, which is illustrated in FIG. 19.

When the computer 200 of the user 5 receives response data from the computer 200 of the different users, the computer 200 of the user 5 updates the field-of-view image 2217-2 to the field-of-view image 2217-3 based on the response data. The update from the field-of-view image 2217-2 to the field-of-view image 2217-3 is based on the processing of Step S1755 by the processor 210, which is illustrated in FIG. 17 and FIG. 18. In the field-of-view image 2217-3, each of the bodies of the different avatar objects 910, 920, and 990 is directed toward the user 5 side. In one aspect, the different avatar object 920 opens the mouth in the field-of-view image 2217-3. In the field-of-view image 2217-3, a character image (“Yes, it is.”) 850 based on an utterance of a different user corresponding to the different avatar object 920 is presented. In another aspect, the mouth of the different avatar object 920 opens, but the character image (“Yes, it is.”) 850 based on the utterance of the different user corresponding to the different avatar object 920 may not be presented in the field-of-view image 2217-3.

[Change in Line of Sight of Different Avatar Object in Another Aspect]

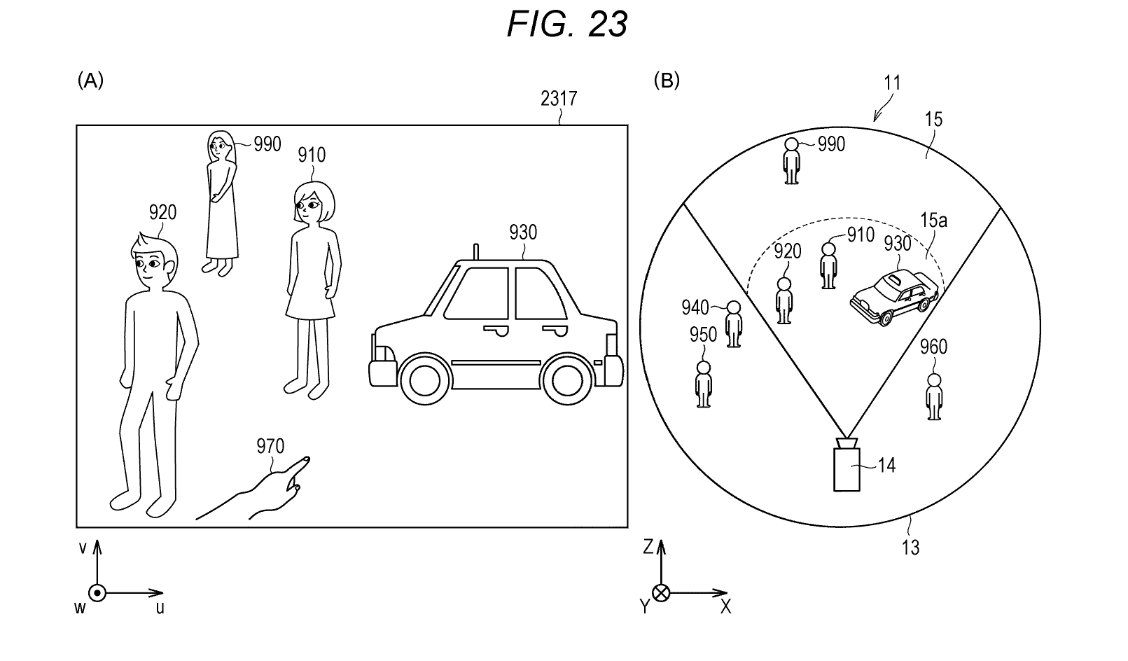

In another aspect, the processor 210 of the computer 200 changes a line of sight of a different avatar object contained in a conversation region 15a. FIG. 23A and FIG. 23B are diagrams for illustrating an example of presentation of an object in the virtual space 11 in another aspect of one embodiment of this disclosure. FIG. 23A is an illustration of a field-of-view image 2317 displayed on the monitor 130 of the HMD 120 in another aspect. FIG. 23B is an illustration of the field-of-view region 15 and the conversation region 15a captured by the virtual camera 14 in another aspect.

As illustrated in FIG. 23B, the field-of-view region 15 contains the conversation region 15a. The conversation region 15a is a region that is closer to the user 5 side (virtual camera 14 side) than the field-of-view region 15 is. In the example of FIG. 23B, the field-of-view region 15 contains the different avatar object 990, whereas the conversation region 23a does not contain the different avatar object 990.

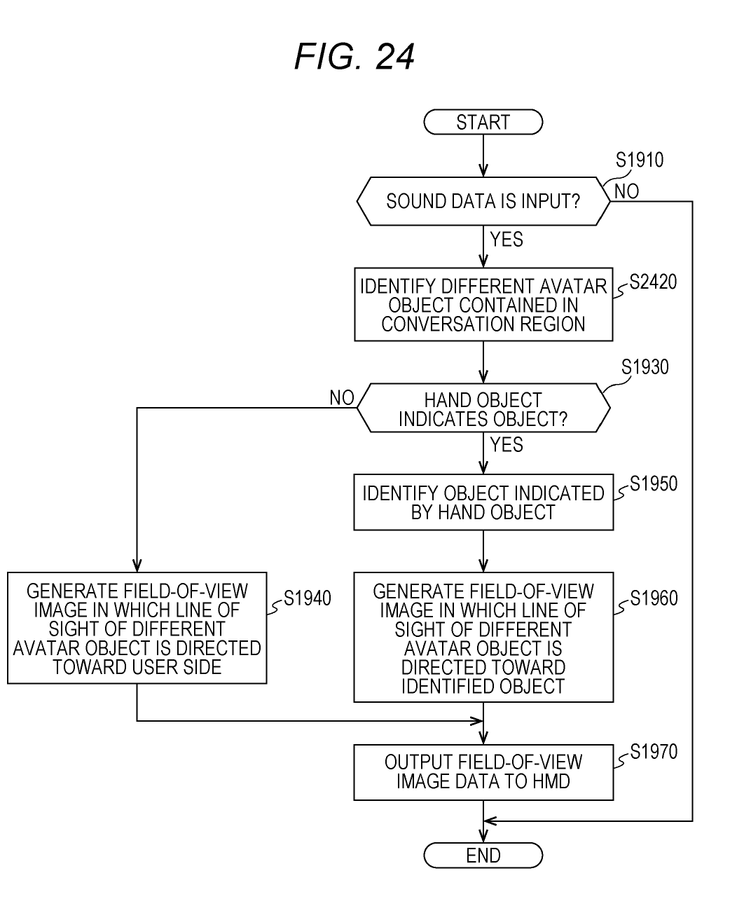

Referring to FIG. 24, a description is given of the control structure of the computer 200 in another aspect. FIG. 24 is a flowchart for illustrating detailed processing to be executed by the processor 210 of the computer 200 in another aspect of one embodiment of this disclosure. In the flowchart illustrated in FIG. 24, Step S1920 of the flowchart illustrated in FIG. 19 is changed to Step S2420. In FIG. 24, the same processing steps as those illustrated in FIG. 19 are denoted by the same step numbers, and hence description of the same processing steps is not repeated.

As illustrated in FIG. 24, when receiving input of sound data from the HMD 120 (YES in Step S1910), in Step S2420, the processor 210 identifies a different avatar object contained in the conversation region 15a. After that, in Step S1940 or Step S1960, the processor 210 generates a field-of-view image in which the line of sight of the identified different avatar object is changed. Specifically, the processor 210 changes the line of sight of the different avatar object contained in the conversation region 15a among different avatar objects contained in the field-of-view region 15.

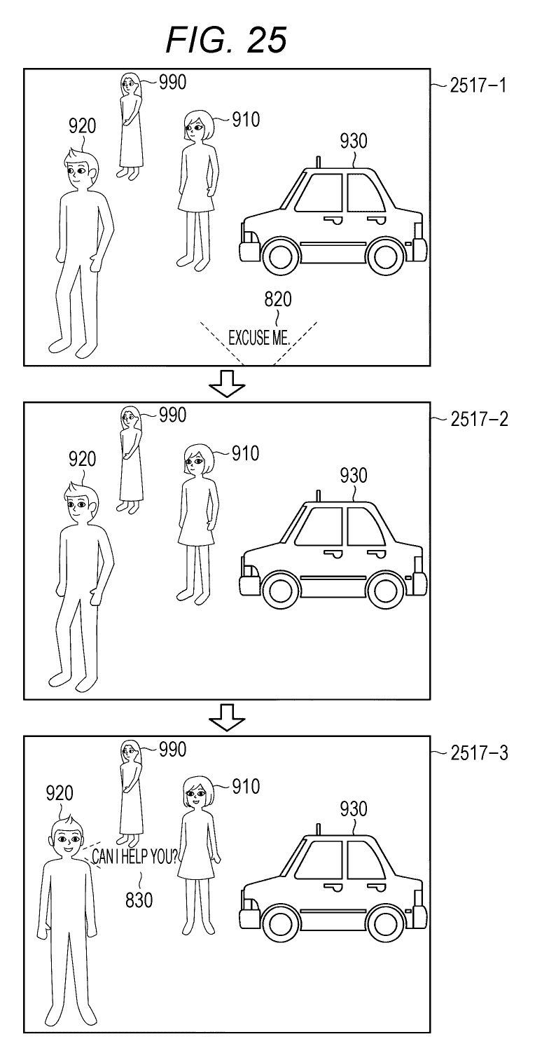

Referring to FIG. 25, a description is given of presentation of an object in another aspect. FIG. 25 is a diagram for illustrating an example of change in object presented in the virtual space 11 in another aspect of one embodiment of this disclosure. FIG. 25 is an illustration of field-of-view images 2517-1 to 2517-3 displayed on the monitor 112 of the HMD 120 in another aspect.

As illustrated in FIG. 25, each of the field-of-view images 2517-1 to 2517-3 contains, as objects contained in the field-of-view region 15, the different avatar objects 910, 920, and 990 corresponding to the respective different users, and the taxi object 930. When the user 5 uses the microphone 170 to give an utterance, the character image (“Excuse me.”) 820 corresponding to the utterance is presented in the field-of-view image 2517-1. Sound data corresponding to the utterance of the user 5 is output to the computers 200 of the different users corresponding to the different avatar objects 910 and 920. Meanwhile, the sound data corresponding to the utterance of the user 5 is not output to the computer 200 of the different user corresponding to the different avatar object 990.

In the field-of-view image 2517-1, the line of sight of each of the different avatar objects 910, 920, and 990 is directed toward a left side of the field-of-view image 2517-1. In the field-of-view image 2517-2 obtained after the user 5 has given the utterance, the line of sight of each of the different avatar objects 910 and 920 is directed toward the side of the user 5, who has given the utterance. Meanwhile, in the field-of-view image 2517-2, the line of sight of the avatar object 990 is not directed toward the side of the user 5, who has given the utterance.

When the computer 200 of the user 5 receives response data from the computer 200 of any one of the different users corresponding to the respective different avatar objects 910 and 920, the computer 200 of the user 5 updates the field-of-view image 2517-2 to the field-of-view image 2517-3 based on the response data. In the field-of-view image 2517-3, each of the different avatar objects 910 and 920 is directed toward the user 5 side. In the field-of-view image 2517-3, the avatar object 920 opens the mouth, and the character image (“Can I help you?”) 830 corresponding to an utterance of the different user corresponding to the avatar object 920 is presented.

[Change of Line of Sight of Different Avatar Object in Another Aspect]

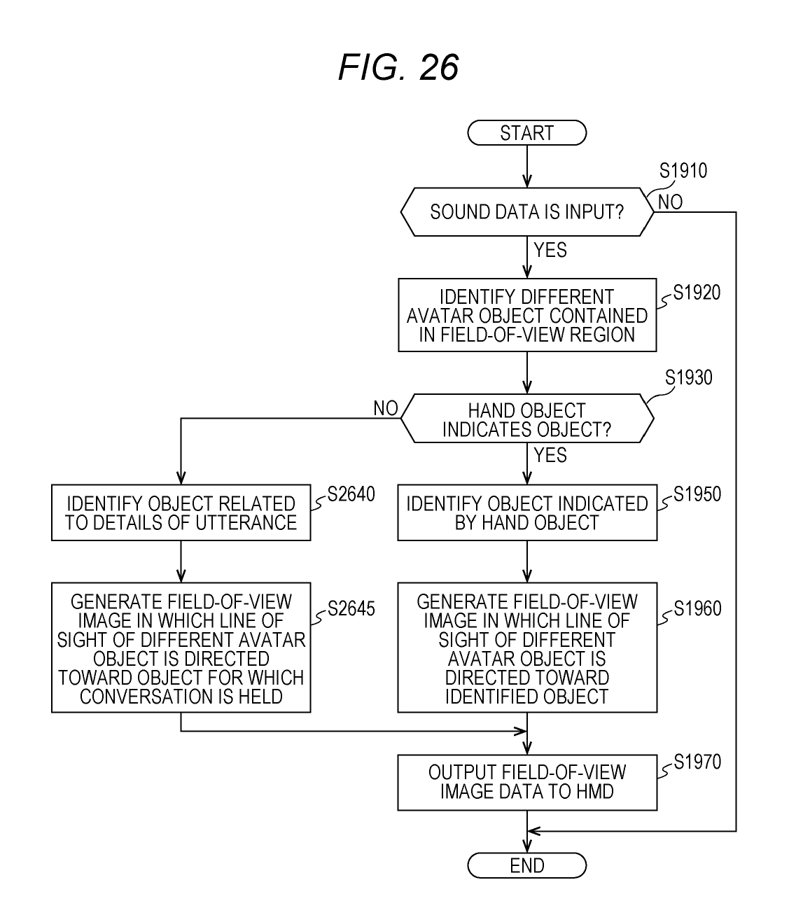

In another aspect, the processor 210 of the computer 200 directs a line of sight of a different avatar object contained in the field-of-view region 15 toward an object related to details of an utterance of the user 5. Referring to FIG. 26, a description is given of the control structure of the computer 200 in another aspect. FIG. 26 is a flowchart for illustrating detailed processing to be executed by the processor 210 of the computer 200 in another aspect of one embodiment of this disclosure. In the flowchart illustrated in FIG. 26, Step S1940 of the flowchart illustrated in FIG. 19 is changed to Step S2640 and Step S2645. In FIG. 26, the same processing steps as those illustrated in FIG. 19 are denoted by the same step numbers, and hence description of the same processing steps is not repeated.

As illustrated in FIG. 26, the processor 210 receives input of sound data from the HMD 120 (YES in Step S1910), and when the hand object does not indicate any object (NO in Step S1930), in Step S2640, the processor 210 identifies an object related to details of the utterance of the user 5. The recognition of the details of the utterance is implemented by a known speech recognition function, for example.

In Step S2645, the processor 210 generates a field-of-view image in which the line of sight of the different avatar object is directed toward the object identified in Step S2640.

In another aspect, the processor 210 may direct a line of sight of a different avatar object contained in the conversation region 15a illustrated in FIG. 23B of the field-of-view region 15, toward an object related to details of an utterance of the user 5.

Further, in another aspect, when the hand object does not indicate any object (NO in Step S1930), and no object related to the details of the utterance of the user 5 can be identified, the processor 210 may generate a field-of-view image in which the line of sight of the different avatar object is directed toward the user 5 side.

[Change of Line of Sight of Different Avatar Object in Another Aspect]

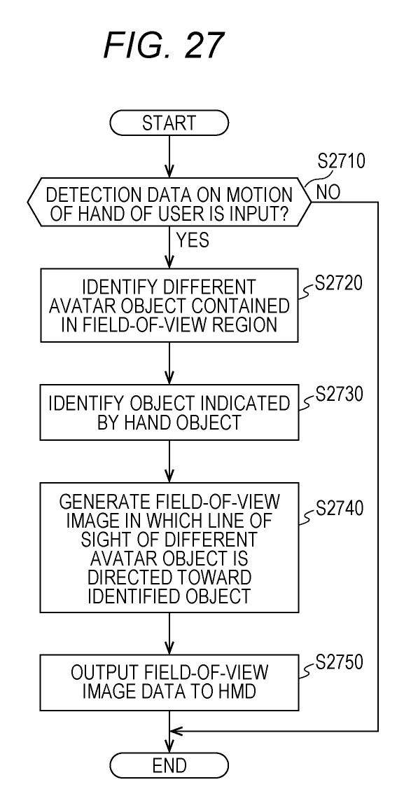

In another aspect, even without receiving sound data corresponding to an utterance of the user, when the motion sensor 420 included in the controller 300 detects a motion of the hand of the user 5, the processor 210 of the computer 200 changes a line of sight of a different avatar object contained in the field-of-view region 15. Referring to FIG. 27, a description is given of the control structure of the computer 200 in another aspect. FIG. 27 is a flowchart for illustrating detailed processing to be executed by the processor 210 of the computer 200 in another aspect of one embodiment of this disclosure.

As illustrated in FIG. 27, in Step S2710, the processor 210 determines whether or not input of detection data on a motion of the hand of the user 5 is received from the motion sensor 420.

When input of detection data on a motion of the hand of the user 5 is not received from the motion sensor 420 (NO in Step S2710), the processor 210 ends the processing.

Meanwhile, when input of detection data on a motion of the hand of the user 5 is received from the motion sensor 420 (YES in Step S2710), in Step S2720, the processor 210 identifies a different avatar object contained in the field-of-view region 15.

In Step S2730, the processor 210 identifies an object indicated by the hand object. For example, the processor 210 identifies, based on a signal generated when the motion sensor 420 detects the motion of the hand of the user 5, an object located on the line extending from the axis of the roll direction illustrated in FIG. 8B.

In Step S2740, the processor 210 generates a field-of-view image in which the line of sight of the different avatar object is directed toward the object identified in Step S2730.

In Step S2750, the processor 210 outputs to the HMD 120 field-of-view image data corresponding to the field-of-view image generated in Step S2750, and ends the processing.

[Other Configurations]

In another aspect, within the time T from when the user 5 gives an utterance to when a different avatar object moves in response to the utterance, the processor 210 of the computer 200 may move at least a part of the body of the different avatar object in addition to moving the line of sight of the different avatar object. For example, within the time T, the processor 210 may move the face of a different avatar object, to thereby move the line of sight of the different avatar object.

In another aspect, within the time T, the processor 210 of the computer 200 may direct a line of sight of a different avatar object toward an object held by a partial object corresponding to a part of the body of the user 5.

In another aspect, in Step S1930, the processor 210 of the computer 200 may determine whether or not an object is located on a line extending from the axis of the yaw direction or the axis of the pitch direction, instead of the axis of the roll direction. In still another aspect, in Step S1930, the processor 210 may determine whether or not, instead of the hand object, a partial object corresponding to a part of the body other than the hand object indicates an object.

In another aspect, in Step S2730, the processor 210 of the computer 200 may identify an object located on the line extending from the axis of the yaw direction or the axis of the pitch direction, instead of the axis of the roll direction. In still another aspect, in Step S2730, the processor 210 may determine whether or not, instead of the hand object, a partial object corresponding to a part of the body other than the hand object indicates an object.

In another aspect, the processor 210 of the computer 200 may present in the virtual space 11 the avatar object corresponding to the user 5, who is associated with the computer 200, in addition to or instead of a different avatar object.

In another aspect, the processor 210 of the computer 200 may determine a volume of an utterance of the user 5 to change the conversation region 23a depending on a result of the determination. For example, when the volume of the utterance of the user 5 is large, the processor 210 may set the conversation region 23a to a region closer to the user 5 than when the volume of the utterance is small.

### SUMMARY OF THIS DISCLOSURE

The disclosed technical features include the following configurations, for example.

(Configuration 1)

According to one embodiment of this disclosure, there is provided a method to be executed by a computer 200 to communicate via a virtual space 11. The method includes the steps of: defining (Step S1610) the virtual space 11; presenting (Step S1650) in the virtual space 11 one or more different avatar objects corresponding respectively to one or more different users to/from which a user 5 of the computer 200 is capable of communicating; receiving (YES in Step S1720 and Step S1910) input of sound data corresponding to an utterance of the user 5 of the computer 200; outputting (Step S1730) the sound data to computers 200 of the one or more different users; moving (Step S1725) the one or more different avatar objects based on response data, which is output from the computers 200 of the one or more different users in response to input of the sound data; and changing (Step S1770, Step S1940, Step S2645, and Step S1960) lines of sight of the one or more different avatar objects within a period of time (time T) from the utterance until the one or more different avatar objects are moved.

(Configuration 2)

According to one embodiment of this disclosure, the step of changing lines of sight of the one or more different avatar objects includes changing (Step S1920a, Step S1940, and Step S1960) a line of sight of a different avatar object contained in a conversation region 15a, which is determined in advance, of a field-of-view region 15 included in the virtual space 11 of the user 5 of the computer 200 communicating via the virtual space 11.

(Configuration 3)

According to one embodiment of this disclosure, the step of changing lines of sight of the one or more different avatar objects includes directing (Step S1940) the lines of sight of the one or more different avatar objects toward a side of the user 5 of the computer 200 communicating via the virtual space 11.

(Configuration 4)

According to one embodiment of this disclosure, the method further includes the steps of: presenting (Step S1670) in the virtual space 11 a hand object 970 corresponding to a hand of the user 5 of the computer 200 communicating via the virtual space 11; detecting (Step S1665) a motion of the hand; and moving (Step S1680) the hand object 970 based on the motion of the hand, and the step of changing lines of sight of the one or more different avatar objects includes directing (Step S1960) the lines of sight of the one or more different avatar objects toward a direction indicated by the hand object 970.

(Configuration 5)

According to one embodiment of this disclosure, the method further includes a step of presenting (Step S1650) an object related to details of the utterance in the virtual space 11, and the step of changing lines of sight of the one or more different avatar objects includes directing (Step S2645) the lines of sight of the one or more different avatar objects toward the object related to the details of the utterance.

(Configuration 6)

According to one embodiment of this disclosure, the response data includes any one of: eye tracking data indicating a result of tracking lines of sight of the one or more different users; face tracking data indicating a result of tracking motions of faces of the one or more different users; and sound data corresponding to utterances of the one or more different users.

(Configuration 7)

According to another embodiment of this disclosure, there is provided a method to be executed on a computer 200 to communicate via a virtual space 11. The method includes the steps of: defining (Step S1610) the virtual space 11; presenting (Step S1650) a different avatar object in the virtual space 11; changing (Step S2740) a line of sight of the different avatar object; presenting (Step S1770) in the virtual space 11 a hand object 970 corresponding to a hand of a user 5 of the computer 200 communicating via the virtual space 11; detecting (Step S1665) a motion of the hand; and moving (Step S1680) the hand object 970 based on the motion of the hand, and the step of changing a line of sight of the different avatar object includes directing the line of sight of the different avatar object toward a direction indicated by the hand object 970 (Step S2730 and Step S2740).

(Configuration 8)

According to one embodiment of this disclosure, there is provided a program for executing any one of the methods described above on a computer.

(Configuration 9)

According to one embodiment of this disclosure, there is provided a computer 200 including: a memory 220 having stored thereon the program described above; and a processor 210 for executing the program.

As described above, according to one embodiment of this disclosure, even when the time T from when the user 5 gives an utterance to when a different avatar object corresponding to a different user moves in response to the utterance increases due to a communication delay or other such factors, the line of sight of the different avatar object is changed within the time T. This prevents the user 5 from feeling strange about a conversation held in the virtual space 11, and thus the interaction among a plurality of users in the virtual space 11 is facilitated.

It is to be understood that the embodiments disclosed herein are merely examples in all aspects and in no way intended to limit this disclosure. The scope of this disclosure is defined by the appended claims and not by the above description, and it is intended that this disclosure encompasses all modifications made within the scope and spirit equivalent to those of the appended claims.

In the embodiment described above, the description is given by exemplifying the virtual space (VR space) in which the user is immersed using an HMD. However, in at least one embodiment, a see-through HMD is adopted as the HMD. In this case, in at least one embodiment, the user is provided with a virtual experience in an augmented reality (AR) space or a mixed reality (MR) space through output of a field-of-view image that is a combination of the real space recognized by the user via the see-through HMD and a part of an image forming the virtual space. In this case, in at least one embodiment, action is exerted on a target object in the virtual space based on motion of a hand of the user instead of the operation object. Specifically, in at least one embodiment, the processor identifies coordinate information on the position of the hand of the user in the real space, and defines the position of the target object in the virtual space in connection with the coordinate information in the real space. With this, the processor is able to grasp a positional relationship between the hand of the user in the real space and the target object in the virtual space, and execute processing corresponding to, for example, the above-mentioned collision control between the hand of the user and the target object. As a result, it is possible to exert action on the target object based on motion of the hand of the user.

1. A method, comprising:
defining a virtual space, the virtual space including a first object and a second object;
detecting a motion of a part of a body of a first user;
moving the first object in response to the motion;
identifying a direction indicated by the moved first object;
identifying a line of sight of the second object; and
changing the line of sight such that the line of sight is directed toward the direction.

2. A method according to claim 1, further comprising:
identifying a field of view of the first user in the virtual space;
identifying a first region, which is a region based on the field of view, and a second region, which is a region other than the first region;
detecting that the second object is contained in the first region;
identifying a third object contained in the second region;
identifying a line of sight of the third object;
changing, in response to inclusion of the second object in the first region, the line of sight of the second object such that the line of sight is directed toward the direction; and
inhibiting, in response to inclusion of the third object in the second region, the line of sight of the third object from being changed such that the line of sight is directed toward the direction.

3. A method according to claim 1,
wherein the virtual space includes a point of view,
wherein the method further comprises identifying a field of view of the first user in the virtual space based on a position of the point of view, and
wherein the direction includes a direction from a position of the second object toward the point of view.

4. A method according to claim 1, further comprising:
determining that the second object has given an utterance in response to the direction;
further presenting a fourth object related to details of the utterance in the virtual space; and
turning the line of sight of the second object toward the fourth object in response to the utterance of the second object.

5. A method according to claim 1,
wherein the second object is associated with a second user,
wherein the method further comprises:
receiving response data output from a second computer associated with the second user; and
moving the second object based on the response data, and
wherein the response data includes any one of:
eye tracking data indicating a result of tracking a line of sight of the second user;
face tracking data indicating a result of tracking a motion of a face of the second user; and
sound data corresponding to an utterance of the second user.

6. A method according to claim 5,
wherein the virtual space includes a point of view, and
wherein the method further comprises:
identifying a field of view of the first user in the virtual space based on a position of the point of view;
identifying a line of sight of the second object based on the eye tracking data;
receiving an utterance of the first user; and
changing, in response to the reception of the utterance of the first user, the line of sight of the second object from a direction that is based on the eye tracking data to a direction from the second object toward the point of view.
